(19) United States
(12) Patent Application Publication
(10) Pub. No.: US 2026/0340226 A1
(43) Pub. Date: Oct. 29, 2026

(54) CONFIGURABLE FIELD AND ENERGY EMULATION SYSTEM AND METHOD

(71) Applicant: James HUTCHISON, Renton, WA (US)

(72) Inventor: James HUTCHISON, Renton, WA (US)

(21) Appl. No.: 19/650,533

(22) Filed: Apr. 17, 2026

Related U.S. Application Data
(60) Provisional application No. 63/793,714, filed on Apr. 24, 2025.

(51) Int. Cl. G06F 30/25

(52) U.S. Cl. CPC G06F 30/25

(57) ABSTRACT

A method includes storing, by at least one processor, information associated with a field comprising a multidimensional array of vectors representing a two-dimensional space or a three-dimensional space, storing, by the at least one processor, information associated with a plurality of energy entities that propagate through the field, each energy entity having a position vector and a velocity vector, performing, by the at least one processor, simulation time steps to generate a simulation of the field, attenuating, by the at least one processor, the multidimensional array of vectors according to a non-linear function that reduces each vector in the multidimensional array of vectors at a rate proportionate to a magnitude of each vector, and smoothing, by the at least one processor, the multidimensional array of vectors by blending neighboring vectors.

### CROSS-REFERENCE TO RELATED APPLICATIONS

This application claims the benefit of U.S. Provisional Application No. 63/793,714 filed Apr. 24, 2025, entitled “FRACTAL UNIVERSE SIMULATOR AND DIRECTED FIELD EMULATION SYSTEM AND METHOD,” the entire contents of which is incorporated herein by reference.

### BACKGROUND

The universe can be thought of as a fractal of particles, whereby a particle is made up of smaller (individually insignificant) particles. These smaller particles may be an order of magnitude smaller, and comprise the field or “spacetime” for which a particle exists. A particle acts as a diffuser to its surrounding environment, meaning that it displaces the smaller particles in its proximity. Particles may have an asymmetric displacement effect due to a variety of abstractable factors, such as polar jets or composite structure. As an example, larger particles can be thought of as energy entities, and the smaller particles that make up the medium it exists in as the field that steers it.

Mentally understanding and visualizing this particle fractal is difficult. At cosmic scale, the fractal plays out, but things are almost frozen in time, and interpreting what is being seen and why, is ambiguous and challenging. At quantum scale, one cannot directly see anything, but can infer existence and see things play out at time scales extremely difficult to measure. True, accurate simulations require a supercomputer and extensive memory. Being able to slice off portions of it, abstract behavior, and see how things behaviorally fit together at consumable time scales substantially improve being able to visualize and create understanding of the mechanics involved.

Additionally, particles can, for various reasons, be bound together to build up and create composite particles, wherein the aggregate effects through an aggregate emergent field can be modeled.

Computational models are frequently used to simulate field behavior, particle interaction, and large-scale structural formation across a variety of domains. Such models often rely on fixed physical equations or predefined propagation rules to approximate observed phenomena.

In many conventional systems, energy propagation dynamics, normalization behavior, and displacement effects are tightly coupled to specific theoretical assumptions, limiting flexibility in exploring alternative rule sets or emergent structural behavior.

Additionally, existing simulation frameworks may not provide configurable mechanisms for modeling field displacement resulting from propagations, field bias accumulation, field bias decay or normalization, and progressive field blending within a unified architecture.

### SUMMARY

According to one aspect, a configurable field and energy emulation system may include one or more computing devices that have a configurable field and energy emulation application. A user may use the computing device to execute the configurable field and energy emulation application. The application provides a field simulation based on a model including energy entities, e.g., propagating particles, that move through a field. The field itself may be based on smaller particles than the energy entities. The energy entities can form loops, which in turn can together form larger particles at higher scales of a particle fractal. As a result, the field simulation can be used to understand how the universe is based on a particle fractal. Conventional solutions use vast amounts of computational power and memory. This system executes the configurable field and energy emulation application and is able to provide substantial savings in computational power and memory as discussed herein.

According to an aspect, a method includes storing, by at least one processor, information associated with a field comprising a multidimensional array of vectors representing a two-dimensional space or a three-dimensional space, storing, by the at least one processor, information associated with a plurality of energy entities that propagate through the field, each energy entity having a position vector and a velocity vector, performing, by the at least one processor, simulation time steps to generate a simulation of the field, each simulation time step including, for each energy entity, calculating a velocity offset based on a weighted average of neighboring velocity vectors in the field, weighted by distance, adding a velocity offset to the velocity vector, and adding the velocity offset to the position vector, for each field position in the field, calculating a value offset based on neighboring energy entities, and adding the value offset to the field position, attenuating, by the at least one processor, the multidimensional array of vectors according to a non-linear function that reduces each vector in the multidimensional array of vectors at a rate proportionate to a magnitude of each vector, and smoothing, by the at least one processor, the multidimensional array of vectors by blending neighboring vectors.

According to another aspect, a system includes a computing device comprising a memory storing computer-readable instructions and at least one processor to execute the instructions to store information associated with a field comprising a multidimensional array of vectors representing a two-dimensional space or a three-dimensional space, store information associated with a plurality of energy entities that propagate through the field, each energy entity having a position vector and a velocity vector, perform simulation time steps to generate a simulation of the field, each simulation time step including, for each energy entity, calculating a velocity offset based on a weighted average of neighboring velocity vectors in the field, weighted by distance, adding a velocity offset to the velocity vector, and adding the velocity offset to the position vector, for each field position in the field, calculating a value offset based on neighboring energy entities, and adding the value offset to the field position, attenuate the multidimensional array of vectors according to a non-linear function that reduces each vector in the multidimensional array of vectors at a rate proportionate to a magnitude of each vector, and smooth the multidimensional array of vectors by blending neighboring vectors.

### BRIEF DESCRIPTION OF THE DRAWINGS

The accompanying drawings illustrate embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1A is a diagram of energy displacing a field according to an example of the instant disclosure.

FIG. 1B is a diagram of an energy entity according to an example of the instant disclosure.

FIG. 1C is a diagram of displacement strength and normalization strength according to an example of the instant disclosure.

FIG. 2 is a diagram of field vectors that steer energy according to an example of the instant disclosure.

FIG. 3 is a diagram showing pressure or field normalization according to an example of the instant disclosure.

FIG. 4 is a block diagram of a configurable field and energy emulation system according to an example of the instant disclosure.

FIG. 5 is a diagram of a flowchart of a method of executing a simulation and displaying a representation of the simulation according to an example of the instant disclosure.

FIGS. 6-29 show screenshots of a graphical user interface of a configurable field and energy emulation application according to an example of the instant disclosure.

FIG. 30 shows an example of a system for implementing certain aspects of the present technology according to an example of the instant disclosure.

### DETAILED DESCRIPTION

The present invention is more fully described below with reference to the accompanying figures. The following description is exemplary in that several embodiments are described (e.g., by use of the terms “preferably,” “for example,” or “in one embodiment”); however, such should not be viewed as limiting or as setting forth the only embodiments of the present invention, as the invention encompasses other embodiments not specifically recited in this description, including alternatives, modifications, and equivalents within the spirit and scope of the invention. Further, the use of the terms “invention,” “present invention,” “embodiment,” and similar terms throughout the description are used broadly and not intended to mean that the invention requires, or is limited to, any particular aspect being described or that such description is the only manner in which the invention may be made or used. Additionally, the invention may be described in the context of specific applications; however, the invention may be used in a variety of applications not specifically described.

The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may effect such feature, structure, or characteristic in connection with other embodiments whether or not explicitly described.

In the several figures, like reference numerals may be used for like elements having like functions even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail. Any signal arrows in the drawings/figures should be considered only as exemplary, and not limiting, unless otherwise specifically noted. Further, the description is not to be taken in a limiting sense, but is made merely for the purpose of illustrating the general principles of the invention, since the scope of the invention is best defined by the appended claims.

It will be understood that, although the terms “first,” “second,” etc. may be used herein to describe various elements, these elements should not be limited by these terms. These terms are only used to distinguish one element from another. Purely as a non-limiting example, a first element could be termed a second element, and, similarly, a second element could be termed a first element, without departing from the scope of example embodiments. As used herein, the term “and/or” includes any and all combinations of one or more of the associated listed items. As used herein, the singular forms “a”, “an,” and “the” are intended to include the plural forms as well, unless the context clearly indicates otherwise. It should also be noted that, in some alternative implementations, the functions and/or acts noted may occur out of the order as represented in at least one of the several figures. Purely as a non-limiting example, two figures shown in succession may in fact be executed substantially concurrently or may sometimes be executed in the reverse order, depending upon the functionality and/or acts described or depicted.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

This disclosure discusses a field simulation capable of demonstrating concepts for understanding how the universe is comprised of a particle fractal, and is designed to run on a consumer-grade computing device. The disclosure also discusses software components that enable this simulation.

At its core, the model includes energy entities—propagating particles that move through a field. In reality, the field itself is composed of much smaller particles. For the simulation, this is abstracted as directional biases that steer the energy entities. These energy entities can form loops, which in turn compose larger particles at higher scales of the fractal.

### Energy Entities and Field Displacement

As energy entities move through the field, they displace the field around them. It is worth noting that an energy entity may not represent a single point-like particle. Rather, it may simply be the center point of a much larger particle whose full extent is not explicitly modeled.

When energy entities displace the field, they can create circular paths. When an energy entity moves in a circular path to create a torus, the surrounding field displacement produces a bias that resembles gravity. One can infer that (and at times visibly see in a three-dimensional (3D) simulator) jets emerge from the center. One can infer that these jets exit with a spin induced from the spinning torus, which is not unlike a magnetic dipole.

### Field Biases and Particle Interactions

Biases in the field can form for several reasons. Polarity naturally creates attraction and repulsion effects between particles. Particles of different sizes will naturally tend to separate from one another.

Because these particles are fundamentally vortexes, the Fujiwhara effect comes into play. Vortexes of similar size and spin naturally repel or orbit each other unless they come into sufficiently close proximity, at which point other dynamics take over.

### Energy Entity Types

### Soliton Energy Entity

A soliton energy entity has a defined displacement pattern and velocity, and is generally free to overlap with other energy entities of the same type. The soliton geometry is more of a computational convenience than a strict reflection of physical reality.

### Diffuser Energy Entity

A diffuser energy entity displaces the field in all directions and is steered by the change in field biases when normalization and other energy entities are considered.

### Normalization/Underlying Chaos

Normalization is the rate at which the field resets toward zero. It models the effect that heat or chaos in the underlying field has in eroding biases over time.

Normalization is controlled by a global parameter (“knob”). The rate of normalization depends on the current bias value: the more biased a region of the field is, the faster it returns toward zero. The rate slows as it approaches zero. This follows a common S-curve pattern—as values approach saturation, the rate of change decreases, and as they rise above an insignificance threshold, the rate increases, with relatively linear behavior in the middle range.

### Field Blending

Field blending is the process by which values on the field average out with neighboring values. The rate of blending is controlled by a configurable parameter.

### Change in Pressure Effects

One option is to model time dilation. However, it became apparent that time dilation was a change in pressure effect, e.g., the derivative of biases. It also may be known as pressure. However, pressure is likely not the correct term and should be taken in an abstract, not literal sense, but describing gravity as a pressure gradient works well and this is referring to the rate of change of the gradient.

An energy entity entering a region of highly increasing pressure is repelled. A knob controls the strength and behavior, and can even go negative. In most cases, it is modeled by a linear as opposed to exponential or logarithmic curve.

### Displacement Shapes

The simulator supports a variety of displacement shapes for soliton energy entities. While many shapes are possible, the most meaningful parameter is the ratio of forward displacement to lateral displacement (where lateral displacement may be perpendicular to the energy entity's direction of travel).

When forward and lateral displacement are well balanced, energy entities can form loops or vortexes, though it requires some effort. When lateral displacement is skewed higher relative to forward, loop formation becomes significantly easier. When lateral displacement is weak and forward displacement is strong, vortexes generally do not form.

### Energy Loop Stability

The stability of energy loops depends on the normalization and blending effects—specifically, whether field biases persist long enough to continue steering energy entities along the necessary looping paths.

Increasing the rate of normalization causes these looping paths to widen and eventually disintegrate. Similarly, changes to blending parameters can destabilize the loops.

### Heat/Chaos Field

One embodiment adds a heat field that maps the amount of thermal energy (or chaos) present in the underlying field. Normalization can be derived from the heat field or added to the baseline normalization rate.

The heat field follows a similar dynamic to normalization itself. As heat increases, its rate of growth slows toward a maximum value. As heat diminishes, its rate of decrease also slows.

### Maximum Field Capacity

Another embodiment adds a maximum capacity to the biases in the field. This works similarly to velocity caps or other limiting functions. The closer a value gets to the maximum, the harder it becomes to increase further. Displacement bleeds to surrounding cells and as you approach the cap, more of this happens. This also slows the energy entity as it approaches the cap.

Normalization does not directly emulate this but often gives similar effects since it hits a balancing point.

### Note on Energy Conservation

None of these behaviors are 100% physically accurate, and in some cases may appear to violate energy conservation. However, when one recognizes that the universe at any point is an open system—where energy can flow through much like a river—this is not a fundamental concern.

There is significant value in being able to quickly recreate conditions and observe their evolution without needing to accurately reproduce a precondition/state that would lead to it.

For example, galaxies likely form at the intersection of jets and where energy congregate over time, so it makes sense energy would net increase over time.

### Practical Results and Observations

For example, recreating the bars of a spiral galaxy is actually rather trivial in this simulation and occurs frequently. The simulation also reproduces patterns that have been mapped to our own Milky Way, including the way coherent paths form within the galactic structure.

Existing literature describes the bars of galaxies as forming through purely gravitational effects. However, traditional models struggle to reproduce the more exotic, elongated bars observed in some galaxies. In contrast, this field simulation has no difficulty demonstrating exotic bars, because in this model they arise from field dynamics rather than from gravitational effects alone.

### Torque

Another embodiment adds torque as a property of both energy entities and the field. As energy entities move through the field, they induce torque in their surroundings. The torque value is derived from the direction of the energy entity relative to the direction of bias in the field.

As the field accumulates torque values, they blend over space. The primary purpose of torque in the simulation is to reveal where emergent phenomena might arise—for example, identifying where magnetism would emerge due to differing directions of spin around a vortex (i.e., different magnetic polarities).

There is a configurable torque sensitivity parameter that controls how strongly energy entities are steered by the torque in the field. This steering is based on the right-hand rule for magnetism.

### Diffuser Entity Movement

Diffuser entity interactions involve two competing effects. First, there is a displacement effect, which is shorter-range and follows a logarithmic falloff. Second, there is the normalization effect, which may be logarithmic, linear, or somewhere in between, but critically extends beyond the range of the displacement effect.

To calculate a diffuser entity's movement, the entity responds to the field and can optionally respond to how its own diffusion pattern would change if left alone. When two diffuser particles are near each other, the normalization effect reduces the diffusion on one side of a particle. This reduction serves as a signal that drives the particle away from the source of that normalization pressure.

Energy entities can also have inverted behavior. Instead of being repelled by a region of the field, they may be attracted to it, and vice versa. The same inversion can apply to diffuser particles.

### Field Types

The simulation supports multiple field types. The term “field type” is somewhat of a misnomer, as both the field behavior and energy entity behavior change together.

### Director Field

In the director field, the absolute bias value is irrelevant—it is used solely for steering. An optional change-in-pressure effect can be added, which causes large changes in field value to slow down energy entities. This is modeled after time dilation. Near a strong gravitational body, greater slowdown occurs.

The change-in-pressure effect creates distinct interior and exterior regions. As entities attempt to exit from the interior, they are repulsed, creating a shell-like boundary—similar to a cell wall or halo.

The director field results in energy propagations always renormalizing the energy to the configured speed. Energy entities are strictly steered by the values of the field, and are slowed by change in pressure effects.

One embodiment incorporates a bias to turn sharper away from the field vector as the lateral displacement factor is increased. Thus a larger lateral displacement factor not only increases the field displaced laterally, but also causes the energy entity itself to turn more aggressively.

An alternative embodiment could instead simply treat the field as a vector field and renormalize the velocity to the configured speed of the energy entity before factoring in a change in pressure logic.

### Vector Field Type

The vector field has the field values interpreted as acceleration vectors. A tunable maximum speed can be set. As it approaches the displacement values the vector field starts to behave more like a director field.

The vector field is more traditional: every bias acts as an acceleration, making it closely analogous to a gravitational field. The change-in-pressure effect can still be applied here, and some behaviors require it.

The lower range the maximum energy entity speed, and the more this behaves like a director field.

### Pressure Field Type

The pressure field steers energy entities by the difference in vector field values. If the displacement and velocity is equal, the acceleration is zero.

The pressure field moves energy entities by changing bias values, rather than having the field value directly accelerate or steer them. This field type is strongly reminiscent of weather patterns and generally produces slower-moving dynamics.

When combined with a carrying capacity and a condensation embodiment that spawns particles when field displacement exceeds a threshold, the pressure field can also produce effects that closely resemble weather phenomena.

### Combined Field Type

The combined field type is a vector field that also deducts the pressure field from the acceleration. Configurable change in pressure effects are disabled. The combined field combines the vector and pressure field and eliminates change in pressure effects.

The simulator allows for arbitrary replication of field behavior on the fractal. The simulator's strongest capabilities are related to reproducing the creation of particles from a medium, using accumulated field biases. This is where one or more large particle(s) is/are created from propagations of particles within a medium. It can also reproduce more complex aggregate behaviors through the tuning of knobs. The field can take on different meanings for the particles, which in turn demonstrates different behavior. For example, the particle propagations, or energy, can be configured to always act at a set speed, and the field values steer them. This is a director field. The particles may alternatively treat the field values as accelerators and have a speed limit. This can be labeled a vector field. The director field is abstractly modeling energy propagations in a given reference frame, while the vector field is modeling the elimination of resistance towards the velocity in a medium.

The simulator is based on user input that may be related to a user adjusting knobs, e.g., user interface elements, to obtain a desired effect. The simulator can also be used to measure observed behavior, e.g., a caliper for field behavior, although abstractions may limit its ability to create real world predictions.

Terminology associated with the system is discussed below.

A directed field is a multi-dimensional array of vectors (or field) altered by propagating energy entities. The energy entities direction vector is altered based on the field values in proximity to the energy position. The field acts like a director to the energy propagation, meaning the vector value is always treated as a unit vector (with a static length).

A vector is a floating point value for each dimension within a given space. A two dimensional simulation would include two values, while a three dimensional simulation would include three.

A field is a multidimensional array of vectors representing an underlying bias over an arbitrary space to simulate.

Energy represents an energy entity, which is a “displacement” structure that propagates through the field. Note that energy may or may not have traits unique to the energy. Energy has a vector indicating its direction and strength, as well as its own properties. Energy may represent different things, depending on the desired context and tuning, so it is not strictly confined to “a particle”.

Settings are parameters that define the behavior of the simulation.

Physics are parameters that define the behavior of the simulation.

A control is a user interface element that allows configuring global and/or per-energy parameters.

A knob is a user interface element providing a tunable parameter of the simulation.

Normalization or normalize refers to reducing biases (either positive or negative) towards zero.

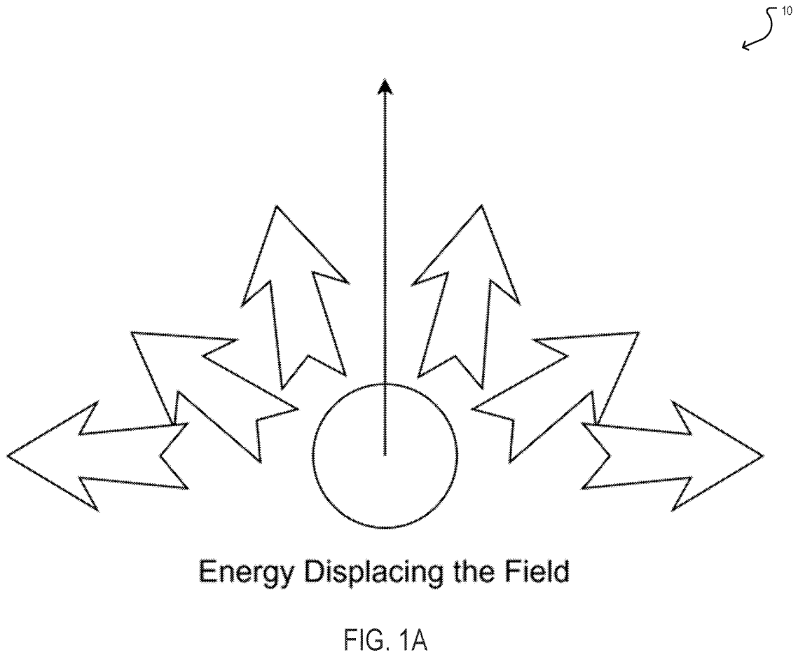

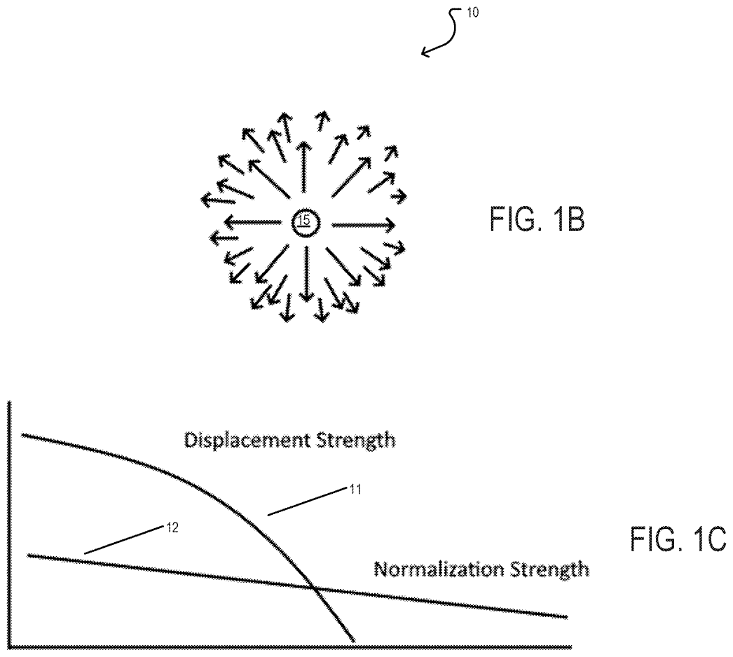

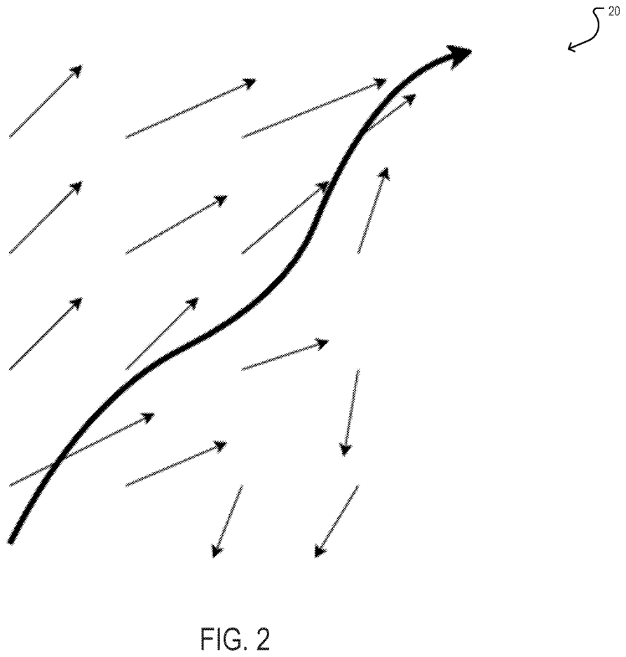

FIG. 1A is a diagram of energy 10 displacing a field, according to an example. Knobs may control the shape, intensity, and behavior of the displacement. FIG. 1B shows an energy entity 15 having energy 10. Additionally, as shown in FIG. 1C, an energy entity may have displacement strength 11 and normalization strength 12. As shown, displacement falls off exponentially while normalization falls off linearly with distance.

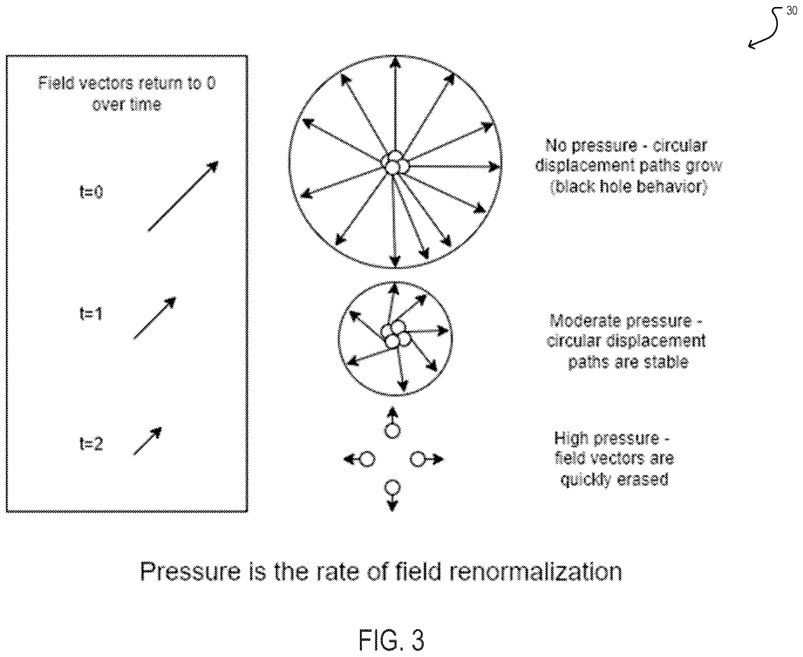

FIG. 2 is a diagram of field vectors 20 that steer energy according to an example of the instant disclosure. FIG. 3 is a diagram demonstrating how field normalization 30 behaves. Over time, bias vectors in the field move towards zero, reducing biases set by previously propagating energy entities.

The desired effect is that a single energy entity being placed would create the appearance of a meteor through the atmosphere, comet through space, or a planet's magnetic shield through the solar wind. As the energy entity moves through the field, the field around it is displaced, and a wake is left behind from earlier propagation. The field normalization as well as a blending effect shrinks the wake with time, causing it to narrow. A second energy entity configured with negative field steering may be placed interior to the wake, pointed in the same direction, and slightly off center. This energy will oscillate around the center point of the wake, and widen it. As the wake widens, the energy will oscillate at stronger angles. If repeated many times, faster than the wake shrinks due to the normalization rate, then the energy will be steered too sharp and escape the wake.

Another desired effect that occurs due to this logic is the propensity to form a loop or orbit around a center point. With sufficient displacement biases and energy propagations approaching each other from appropriate angles, a loop of energy forms. Energy exterior to the loop, but close enough to be affected, imitates gravitational bodies, and with sufficient speed and carefully balanced configuration, can imitate an orbit. Increasing the normalization rate can erase the biases too quickly, causing the loop to widen and eventually destabilize.

The desired effects are balanced by the speed of energy, rate of normalization, rate of steering, and strength of displacement. If the energy speed is too slow, then it spends too much time on the same field variables and loses the granularity necessary to create the desired effects. If it is too fast, a much larger field is necessary, substantially increasing computational and memory overhead. Additionally, if the rates are not well balanced, then normalization will overwhelm displacement, steering may be too erratic, and displacement may overwhelm everything else, etc.

Since these factors are tunable, moving them out of balance has the utility of demonstrating why the balance is important, and also can be used for experimenting with different scenarios. For example, with very high displacement and very high normalization, energy can bond together to form structure.

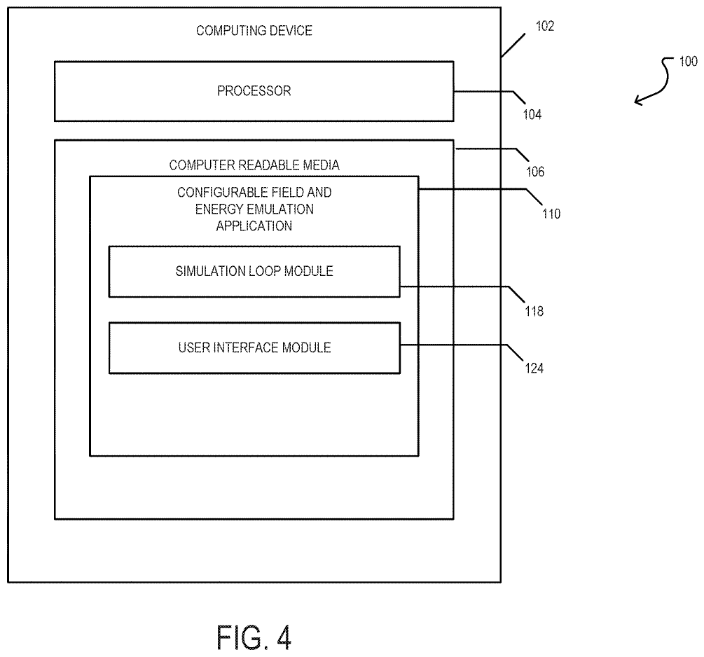

FIG. 4 shows a block diagram of a configurable field and energy emulation system 100 according to an example of the instant disclosure.

In one example, the system 100 includes a simulation loop and a user interface that displays information associated with the simulation loop. In one example, the simulation loop can be a game engine type loop with a time measurement between each iteration. Examples may include a “while true” logic statement, or hooking into a game engine's frame rendering calls, or other similar means of accomplishing the same task. However, a game engine or similar library is just an example. The clock time is measured between frames, and is enforced to ensure operating system hitches do not cause erratic behavior. Higher values introduce simulation artifacts. Lower values will induce slow down when the system running cannot keep up. Different components will scale the output by the elapsed time, and clamp the maximum change by the maximum change in time.

The configurable field and energy emulation system 100 may include at least one computing device 102 that is in communication with other computing devices via a communication network. The at least one computing device 102 may have an application or at least one component of an application, e.g., a configurable field and energy emulation application 110.

The computing device 102 is configured to receive data from and/or transmit data to other computing devices through the communication network. Although the at least one computing device 102 is shown as a single computing device, it is contemplated that the at least one computing device 102 may include multiple computing devices.

The communication network can be the Internet, an intranet, or another wired or wireless communication network. For example, the communication network may include a Mobile Communications (GSM) network, a code division multiple access (CDMA) network, 3^{rd} Generation Partnership Project (GPP) network, an Internet Protocol (IP) network, a wireless application protocol (WAP) network, a WiFi network, a Bluetooth network, a Bluetooth Low Energy (BLE) network, a Bluetooth mesh network, a satellite communications network, and an IEEE 802.11 standards network, among others. Other conventional and/or later developed wired and wireless networks may also be used.

The at least one computing device 102 includes at least one processor 104 to process data and memory to store data. The processor processes communications, builds communications, retrieves data from memory, and stores data to memory. The processor 104 and the memory are hardware. The memory may include volatile and/or non-volatile memory, e.g., a computer-readable storage medium 106 such as a cache, random access memory (RAM), read only memory (ROM), flash memory, or other memory to store data and/or computer-readable executable instructions such as a portion or component of the configurable field and energy emulation application 110. In addition, the at least one computing device 102 further includes at least one communications interface to transmit and receive communications, messages, and/or signals.

The at least one computing device 102 can be a laptop computer, a smartphone, a personal digital assistant, a tablet computer, a standard personal computer, or another processing device. The at least one computing device 102 may include a display, such as a computer monitor, for displaying data and/or graphical user interfaces. The at least one computing device 102 may also include an input device, such as one or more cameras, a keyboard or a pointing device (e.g., a mouse, trackball, pen, or touch screen) to enter data into or interact with graphical and/or other types of user interfaces. In an example, the display and the input device may be incorporated together as a touch screen of the smartphone or tablet computer.

The at least one computing device 102 may display on the display a graphical user interface (or GUI). The graphical user interface may be provided by the configurable field and energy emulation application 110. The graphical user interface enables a user of the at least one computing device 102 to interact with the configurable field and energy emulation application 110.

The configurable field and energy emulation application 110 may be a component of an application and/or service executable by the computing device 102. For example, the configurable field and energy emulation application 110 may be a single unit of deployable executable code or a plurality of units of deployable executable code. According to one aspect, the configurable field and energy emulation application 110 may include one component that may be a web application, a native application, and/or a mobile application (e.g., an app) downloaded from a digital distribution application platform that allows users to browse and download applications developed with mobile software development kits (SDKs) including the APPLE App Store and GOOGLE PLAY®, among others.

The system 100 may also include a relational database management system (RDBMS) or another type of database management system such as a NoSQL database system that stores and communicates data from at least one database. The data stored in the at least one database may be associated with the configurable field and energy emulation application 110 including information associated with cosmological effects, atoms, molecules, heat effects, phases, electrostatic pressure, magnetism, quantum folding, behavioral and biological science, among other information.

In one example, the configurable field and energy emulation application 110 may include a simulation loop module 118 to execute high level simulation logic discussed herein associated with the simulation.

The configurable field and energy emulation application 110 may include a user interface module 124 to display a user interface on the display of the computing device 102. The user interface module 124 may generate a native and/or web-based graphical user interface that accepts input and provides output views by users of the computing device 102. The computing device 102 may provide realtime automatically and dynamically refreshed configurable field and energy emulation information. The user interface module 124 may send data to other modules of the configurable field and energy emulation application 110 and retrieve data from other modules of the configurable field and energy emulation application 110 asynchronously without interfering with the display and behavior of the user interface displayed by the computing device 102.

High level simulation logic associated with the simulation loop provided by the simulation loop module 118 is discussed below.

First, there is a measurement between frames known as deltaTime.

In one example, the maximum deltaTime value may be: 0.02. Additionally, the simulation may be paused. If paused, the logic of the simulation's time based logic does not run. The time based logic may include: modifying “energy” data via High Level Energy Logic and modifying “field” data via High Level Field Logic. High Level Energy and Field Logic may run sequentially or asynchronously, and may be in any order.

### High Level Energy Logic

The focus of the high level energy logic is to reposition energy entities based on their velocity vector. This is done by examining the field neighboring the energy entity and calculating a new velocity vector based on the displacements. Depending on the field and energy type, as well as energy properties, the energy will behave differently. Once a velocity vector is calculated, it is scaled by deltaTime, and then applied velocity is scaled by deltaTime when added to the energy entity's position.

The high level energy logic may include: for each energy, obtaining a closest field cell's coordinates to the energy's position, obtaining a displacement vector for the field cell that best fits the position of the energy, optionally improving accuracy by interpolating a vector from neighboring cells, obtaining the displacement vector for the next grid cell, optionally improving accuracy by interpolating a vector between next cell candidates, obtaining energy redirection, using displacement vectors and knobs, adding redirection vector, scaled by deltaTime, to energy velocity vector, and add velocity vector to energy's position.

The field may or may not “wrap” around. This could be configurable using a setting. If the field wraps, the logic may have to account for it using modulus operations.

### High Level Field Logic

The focus of the high level field logic is related to updating the field values based on the positions of energy and velocity vectors of energy. Depending on the energy type, the field is displaced differently. There are typically three operations done on the field, although any operation could in theory be tuned to be zero and thus be skippable. These three operations are: applying displacements from energy, blending values between field cells, and “normalizing” the field values towards zero.

The high level field logic may include: for each energy, for each meaningfully close grid cell (set by a distance threshold), determining the field displacement from the energy's current velocity vector, the relative offset this cell is from the energy, and knob values, applying the displacement to the current displacement, optionally having a knob determine the form of this alteration (such as linear versus logarithmic, etc.), applying field blending logic, and applying field normalization logic.

In one example, the new displacement is always applied linearly (old+new).

### Energy Redirection Logic

The redirection logic determines the change in velocity vector for an energy entity, based on the field value at its current and future location (based on velocity), as well as knobs and energy properties. This implementation is for the director field.

The energy redirection logic may use the following parameters: energy velocity vector, displacement vector, next displacement vector, lateral displacement factor (knob), and field steering factor (knob).

If a magnitude of displacement is approximately zero, and parent field skew are zero, return early. If the velocity is approximately zero, return early. Obtain the adjusted forward displacement vector as adjustedDisplacement.

Adding to the existing energy velocity vector (adjustedDisplacement*(Field steering factor)).

The vector field energy redirection logic may use the following parameters: energy velocity vector, displacement vector, field steering factor (knob). If displacementVector magnitude is very small, simply return energyVelocityVector. Multiply the displacement vector by the field steering factor to get the accelerationVector. And then return accelerationVector+energyVelocityVector.

The pressure field energy redirection logic may use the following parameters: energy velocity vector, displacement vector, and field steering factor (knob). If displacementVector magnitude is very small, simply return energyVelocityVector. Multiply the displacement vector by the field steering factor and negative 1 to get the newVelocityVector. And then return newVelocityVector.

### Field Displacement Logic

The field displacement logic may include and use the following parameters: energy velocity vector, cell offset vector, displacement strength (knob), displacement falloff rate (knob), energy size, and lateral displacement factor (knob).

“Return early” means a vector with x=0, y=0 is returned. Distance may be calculated or passed in as the magnitude of cell offset vector. If distance is zero, return early. Clamp distance to a minimum value.

In one example, 0.2 is the minimum value.

Next, calculate the falloff factor.

size/(size+(clampedDistance\hat{ }2*(Displacement falloff rate+0.01)))

Magnitude=Calculate the magnitude scalar.

(Displacement strength\hat{ }2)*(Displacement falloff factor).
Obtain the speed of the energy.
Speed=magnitude energy velocity vector.

NormVx, NormVy=Normalize energy velocity.

Next, determine the lateral vector from the normalized vector.

LateralX=normVy*−1

LateralY=normVx

Next, determine the forward component of the normalized vector.

forwardComponent=(offsetX*normVx+offsetY*normVy)

If the forward component is <0, return early (half dome displacement)

Next, determine lateralComponent

offsetX, offsetY=Cell offset vector

offsetX*lateralX+offsetY*lateralY

Next, determine the forwardFactor.

displacementSizeFactor=3

In one example, this is tuning to get the desired effect with size of 1.

Next, take the size and divide by displacementSizeFactor*(lateral displacement factor).

In one example, the maximum energy size via the UI is 5.

Clamp value inclusively.

In one example, clamp is 0.05<=value<=0.95.

Next, calculate the sideFactor

=(1−forwardFactor)*(Lateral displacement factor).

Return the displacement vector as follows:

X: (normVx*forwardComponent*forwardFactor)−(lateralX*lateralComponent*sideFactor)

Y: (normVy*forwardComponent*forwardFactor)−(lateralY*lateralComponent*sideFactor)

Multiply x, y by magnitude and (Energy Size\hat{ }2).

And then, return the displacement vector.

A separate logic branch is used when the energy entity type is a diffuser type. If the energy entity type is the diffuser type, then there are three additional parameters considered including existing field value/displacement as a vector, diffuser strength factor (knob or energy entity property), and diffuser normalize factor (knob or energy entity property). Other parameters used may include strength, offset of the field relative to the energy entity as a vector, sizeScalar=size\hat{ }2, falloffFactorNormalization=size/(size+distance),

normalizeMagnitude=strength\hat{ }2*falloffFactorNormalization. Next, return a vector with each dimension as: ((existingDisplacement*−diffuserNormalizeFactor*normalizeMagnitude)+(diffuserStrengthFactor*magnitude*offset))*sizeScalar.

In some embodiments, diffuser strength may be multiplied by a negative one. In a 2D embodiment, the diffuser displacement may be described as a composite field-writing operation having at least two separable effects across surrounding cells of a 2D field grid. A first effect is an outward displacement contribution centered on the diffuser and distributed substantially omnidirectionally in the plane, with strength decreasing as a function of radial distance from the diffuser. A second effect is a normalization contribution that tends to reduce or counterbalance existing field displacement already present in the surrounding 2D region. In the current example embodiment, the outward contribution and the normalization contribution use different distance relationships so that the outward component remains locally dominant near the diffuser while the normalization component persists farther from the center. This permits the diffuser to create a directional imbalance in the local field and thereby self-propel, repel nearby diffusers, or enter orbital-like motion around neighboring structures instead of merely canceling its own field.

The diffuser displacement in the 2D example embodiment may be calculated from the diffuser's planar offset relative to each affected grid cell, the diffuser size, a displacement strength parameter, a distance-based falloff parameter, and the pre-existing field displacement at that cell. The normalization portion may operate against the pre-existing local displacement vector, while the outward portion may be applied radially from the diffuser center. The combined result may then be written into the 2D field as a new displacement contribution. The displacement operation may optionally be inverted.

In the Field Displacement Logic the 2D embodiment uses lateral X and Y coordinates such as:

LateralX=normVy*−1

LateralY=normVx

The LateralComponent is: offsetX*lateralX+offsetY*lateralY.

In the 3D embodiment there may be:

forward=normalize(velocity).

forwardComponent=dot product of offset vector and forward vector.

lateral=offset vector−forward*forwardComponent.

lateralDir=normalize lateral (vector).

lateralComponent=length of lateral.

displacementVector=(forward*forwardComponent*forwardFactor−lateralDir*lateralComponent*sideFactor)*magnitude.

### Torque

Torque is a spin component in the underlying field and energy entity, relative to the displacement or velocity direction. Torque transfers to the field via the movement of energy entities. Energy entities receive torque via the field and a tunable sensitivity parameter.

The torque embodiment is dimensionally sensitive. The two dimensional embodiment is as follows. As energy propagates through the field, the field cells to the immediate left (e.g., a first direction) receive negative torque and the field cells to the right (e.g., a second direction) receive positive torque. If the energy entity is sensitive to field torque, then it will absorb positive or negative values from the field, and will bias to the right with a positive torque and bias to the left with a negative torque.

Three dimensional torque is more complex and motion biases are sensitive to alignment and the induced motion biases that are perpendicular to the difference between the field displacement vector and the energy entity velocity vector.

Property changes:

Both 2D and 3D embodiments add torque as a scalar property of either an energy entity or a field cell.

Knobs:

Torque Sensitivity—a factor of how much an energy entity responds to the torque of the underlying field

Display torque—knob to show torque in the field

### High Level Torque Logic

Torque is added to the field by augmenting the Field Displacement Logic. If the distance of the field cell relative to the energy entity is less than or equal to the maximum distance threshold (2D:1, 3D:2) and greater than zero: [A] Calculate the raw torque applied using displacement using Torque Calculation Logic. [B] Calculate the transferred torque from the energy entity itself using Energy to Field Transferred Torque Logic. Calculated torque (both A and B) are scaled by the difference in time between frames and constrained by the maximum frame time (deltaTime used throughout as the example). Subtract [B] from the energy's torque. Add the result of [A] and [B] to the field's torque.

### Torque Calculation Logic 2D

A current velocity vector, an existing field vector, and an applied influence vector are identified for the energy element. The magnitude of the existing field vector and the magnitude of the velocity vector are determined. If either the existing field vector or the velocity vector has zero magnitude, the process returns a torque value of zero, thereby avoiding rotational calculation where directional reference is absent. The existing field vector is normalized to obtain a unit existing-direction vector. The velocity vector is normalized to obtain a unit motion-direction vector. An alignment value is calculated between the unit existing-direction vector and the unit motion-direction vector, such as by a dot-product operation, to represent the degree to which the existing field is oriented with the current direction of motion. A transverse interaction value is calculated between the unit existing-direction vector and the applied influence vector, such as by a two-dimensional cross-product operation, to represent the extent to which the applied influence acts perpendicularly relative to the existing field.

A torque value is then generated as a signed function of both the transverse interaction value and the alignment value, for example, as the negative product of those two values. The resulting torque value represents a rotational influence that increases when the applied influence has a stronger perpendicular component relative to the existing field and when the existing field is more closely aligned with the direction of motion.

### Energy to Field Transferred Torque Logic 2D

A current velocity vector, an existing field vector, an energy torque value, and a field torque value are identified for an energy element. The magnitude of the existing field vector and the magnitude of the velocity vector are determined. If either the existing field vector or the velocity vector has zero magnitude, the process returns a transferred torque value of zero, thereby avoiding transfer calculation where directional reference is absent. The existing field vector is normalized to obtain a unit existing-direction vector.

The velocity vector is normalized to obtain a unit motion-direction vector. An alignment value is calculated between the unit existing-direction vector and the unit motion-direction vector, such as by a dot-product operation, to represent the degree to which the existing field is oriented with the current direction of motion. A torque differential is determined from the energy torque value and the field torque value, for example by subtracting the field torque value from the energy torque value. A transferred torque value is then generated by scaling the torque differential according to the alignment value.

The resulting transferred torque value represents rotational transfer between the energy component and the field component, such that the transfer is increased when the existing field is more closely aligned with the direction of motion and reduced when such alignment is weaker. If the alignment is reversed (field vector and direction of motion are opposing orientation), then the sign of the transferred torque reverses as well.

### Torque Calculation Logic 3D

A current velocity vector, an existing field vector, and an applied influence vector are identified for an energy element. The existing field vector is normalized to define a reference axis for rotational sign and direction. A lever-arm vector is derived from the velocity vector by reversing its direction, such that the lever-arm vector extends opposite to the current direction of motion. A torque vector is calculated from the lever-arm vector and the applied influence vector, such as by a three-dimensional cross-product operation, to represent rotational tendency produced by the applied influence about the lever arm. A scalar torque value is then determined by projecting the torque vector onto the normalized existing field axis, such as by a dot-product operation.

The resulting scalar torque value represents the signed rotational influence about the existing field axis, such that the sign indicates rotational direction relative to that axis and the magnitude indicates the extent of rotational effect contributed by the applied influence.

### Energy to Field Transferred Torque Logic 3D

A motion vector, an existing directional field vector, an energy torque quantity, and a field torque quantity are identified for an energy element. The existing directional field vector is normalized to obtain a reference field direction. The motion vector is normalized to obtain a reference motion direction. A directional alignment value is determined between the reference field direction and the reference motion direction, such as by a dot-product or projection operation.

A torque differential is determined from the energy torque quantity and the field torque quantity, for example, by subtracting the field torque quantity from the energy torque quantity. The torque differential is scaled according to the directional alignment value to generate a transferred torque quantity. The transferred torque quantity represents rotational transfer between the energy component and the field component, such that the transfer varies in accordance with the degree to which the existing directional field is aligned with the direction of motion.

### Energy Steering Due to Torque

When updating energy velocity vectors, torque causes the energy to turn in addition to the field values. This is triggered if the energy entity has torque sensitivity that is nonzero. This logic calculates induced torque induced on the energy entity due to the field, adds/subtracts to the velocity vector, and optionally deducts the induced torque from the field value.

### Energy Torque Steering Logic 2D

Compute the baseline redirected velocity vPost from the field logic for the current fieldType. This is the velocity the particle would take before any torque adjustment.

Read the particle's current velocity vPre and normalize both vPre and vPost to get direction-only vectors. Compute the directional alignment using the dot product of the normalized vectors: alignment=clamp(dot(nPre, nPost), −1, 1).

Read the particle torque and local cell torque:

energyTorque=energy.torque
fieldTorque=cell.torque

Compute the torque difference between the field and the particle:

torqueDiff=fieldTorque−energyTorque. Scale that torque difference by directional alignment to get the induced target torque: targetTorque=alignment*torqueDiff. This means torque coupling is strongest when pre- and post-redirection directions are aligned, and it reverses sign when they are opposed. Compute the torque update applied this frame and apply the torqueSensitivity knob and any appropriate scaling to avoid the strength being too strong, causing energy to always spin in circles, or too weak and make no meaningful difference: torqueFactor=(targetTorque−energyTorque)*deltaTime*torqueSensitivity*0.15.

Rotate the redirected velocity vPost by torqueFactor. This applies torque as an angular adjustment to the field-redirected motion rather than changing speed directly. Update the particle's stored torque: updatedEnergy.torque=energyTorque+torqueFactor. Optionally deduct the torqueFactor from cell.torque. Continue the rest of the particle update using this torque-rotated velocity.

### Energy Torque Steering Logic 3D

Compute the baseline redirected velocity redirectionResult.vector from the field logic for the current fieldType. This is the candidate velocity before torque is applied. Set velocity to the redirected velocity and displacement to the current cell's displacement. Normalize both vectors so the torque calculation depends on direction rather than magnitude. Compute the alignment between the redirected velocity and the field displacement: alignment=clamp(dot(nVelocity, nDisplacement), −1, 1). Read the particle torque and field torque:

energyTorque=energy.torque
fieldTorque=cell.torque

Compute the torque difference: torqueDiff=fieldTorque−energyTorque. Convert the alignment into a weighted factor: ((alignment*0.5)+(sign(alignment)*0.5)). This biases the response so positively aligned motion couples more strongly to the field torque.

Compute the target induced torque: targetTorque=(((alignment*0.5)+(sign(alignment)*0.5))*torqueDiff). Compute the torque update for the current frame, apply the torqueSensitivity knob and any appropriate scaling to avoid the strength being too strong, causing energy to always spin in circles, or too weak and make no meaningful difference: torqueFactor=(targetTorque−energyTorque)*deltaTime*torqueSensitivity\hat{ }3*0.25. Use the normalized field displacement direction as the rotation axis. If that axis has non-zero length, rotate the redirected velocity around it by torqueFactor, and update the stored torque:

updatedEnergy.velocity=rotate(velocity, axis, torqueFactor)
updatedEnergy.torque=energyTorque+torqueFactor
Optionally deduct the torqueFactor from cell.torque.

If the axis length is effectively zero, skip the rotation and keep the redirected velocity unchanged.

### Field Blending Logic

The field blending logic merges field values with its neighbors. Higher values create smoother and more spherical displacement effects but also actively fight the formation of biases that create more interesting behavior. The field blending logic may include and use the following parameters: Field Blend Rate (knob).

In one example, this may be based on averaging neighbors in the field grid.

Blending logic may include the following: If propagation rate/blend rate is 0, return. Make a copy of the grid. For each grid cell, obtain the cardinal neighbors (up/down/left/right) and obtain their displacements (using the copy). Next, obtain the average X/Y (/Z) displacement of the neighbors. Then, update the X/Y/(/Z) displacement of the current cell's dimensions to ((average of neighbors)−(current displacement))*Propagation Rate*deltaTime.

### Field Normalization Logic

The field normalization logic may include and use the following parameters: Field Normalization Factor (knob).

For each cell scale displacement by (1−(Field Normalization Factor)*deltaTime).

### Adjusted Forward Displacement Vector Logic

The forward displacement vector is used to determine the ratio of displacement in the forward versus lateral direction relative to the velocity direction of an energy entity. This ties the lateral displacement factor to forward resistance, meaning that the energy entity is going to turn sharper away from the field vector's direction as lateral displacement is increased. Essentially, “forward resistance” is incorporated and the stronger the lateral displacement, the greater the forward resistance and weaker the velocity vector in the forward direction. Since the velocity is always renormalized back to the configured speed, this resistance only affects steering.

The adjusted forward displacement vector logic may include and use the following parameters: lateral displacement factor (knob). Normalize the energy velocity if not done already. Obtain the dot product of the displacement vector and normalized energy velocity vector. Project the forward vector (forwardVec) by multiplying the normalized vector by the dot product. Obtain the lateral displacement vector by subtracting the forward vector from the displacement vector.

displacementRatio=max(dot product, 0.0001)

inverseResistance=min(1, 1/displacementRatio)

forwardResistance=(lateral displacement factor\hat{ }2)*inverseResistance

clamp forwardResistance to a maximum of 1

return forwardVec scaled by (1−forwardResistance)

### Apply Change in Field Normalization Logic

Change in field normalization effects alter the velocity of an energy entity based on the difference in field values between the energy entity's current and future position. For a director field, this is the only thing that influences energy speed. If gravity is modeled as a field normalization gradient, then “time dilation” roughly is this effect.

Change in field normalization logic may include and use the following parameters: change in pressure factor, redirection vector, velocity vector (e.g., this may be the energy's speed), current (closest) cell's displacement, and next (closest) cell's displacement.

If changeInPressureFactor is 0, or the displacement vector is near zero, return early. Calculate the difference in displacement between the next cell and the current cell as a vector. If the magnitude of the vector is near zero, return early. Obtain magnitudeRatio by dividing the displacement difference magnitude by the velocity magnitude. Normalize the displacement difference (vector). Obtain the alignment by taking the dot product of the normalized displacement difference vector and the normalized velocity vector.

In one example, the system supports linear versus squared timeScale by comparing the timeFactor. If it is greater or equal to 2, then the square formula is used. Otherwise, the linear formula is used.

If timeFactor greater or equal to 2

velocityScale=1+signed square((alignment*magnitudeRatio*(changeInPressureFactor−1)).

Otherwise, if timeFactor is less than 2 velocityScale=1+alignment+magnitudeRatio+changeInPressureFactor.

Then, scale energy vector by velocityScale.

### High Level Diffuser Logic

Diffusers are energy entities that emulate particles that can move based on the surrounding field values rather than strictly the immediate field values. In a “zeroed” environment, they would not move at all. Asymmetry in the surrounding field result in them being repelled or “orbiting” other diffusers of equal strength. The desired effect is that diffusers displace the field around them in all directions, and consequentially, when “tipped” in a direction, progress through the field, creating momentum. There's an additional, counteractive effect, of the edges of the diffuser's displacement radius normalizing (reducing towards zero) the field in all directions. The distance to strength relationship of the field displacement must start stronger and fall off sharper than the distance to strength relationship of the normalization. Otherwise, the diffuser particle would simply normalize around it.

The base type of energy entity is called a “soliton”. A “soliton” type propagates through the field, and is steered by the biases in the field. A “diffuser” type moves based on asymmetry in the biases. This creates momentum from its own movement, as well as a potentially repulsive or attractive effects to peer diffuser types.

As an example, displacement falls off exponentially while normalization falls off linearly with distance. The logic used for the diffuser amounts to several logical components, done per frame:

A component to modify the field around it, based on the energy and field properties

A component to analyze the field around it, and compare it to the expected versus actual value, and to alter the velocity vector based on the difference.

A component to alter the energy entity vector based on the field value itself.

First a copy of the field is made.

[A] The component to modify the field around it takes in a diffuser particle and applies displacement based on the configuration. This deviates from the soliton style energy in that the diffusion doesn't have a preferred direction, and thus displaces omnidirectionally. The displacement can be inverted as well.

[B] The movement of the diffuser is a combination of analyzing the field in proximity to the diffuser particle and soliton style energy movement. The “diffuser only” velocity logic examines the field surrounding the diffuser, and applies a repulsive velocity vector based on the differences in each cell and its distance from the diffuser.

The soliton style logic remains unchanged. The velocity vector results from repulsion and typical steering is simply added to create a final value.

The per-frame logic then includes the following: copy the current field data, make changes to the field from energy entities, inclusive of [A], use [B] to calculate a new velocity vector for diffuser particles, and all other changes to the field and energy entities.

Example Knobs (e.g., example graphical user interface elements) may include the following:

### Energy Speed Knob

The energy speed knob may be used to adjust the propagation speed of energy.

### Energy Size Knob

The energy size knob may be used to adjust the abstracted size of energy. Field sensitivity scales linearly with the size.

### Energy Field Steering Knob

The energy field steering knob may be used to adjust a value indicating whether the energy turns towards or away from the field. A value of −0.5 emulates gravity and will converge in a well of energy. A positive number emulates anti-gravity and will actively resist wells

### Displacement Strength Knob

The displacement strength knob may be used to adjust the overall displacement strength of energy.

### Lateral Deflection Knob

The lateral deflection knob may be used to adjust the amount of displacement that is lateral rather than forward.

### Falloff Rate Knob

The falloff rate knob may be used to adjust the rate of falloff from displacement.

### Field Normalization Knob

The field normalization knob may be used to adjust the rate the field renormalizes.

### Blend Rate Knob

The blend rate knob may be used to adjust the rate field values are blended with neighbors. This may be similar to pressure but only happens to propagating displacements.

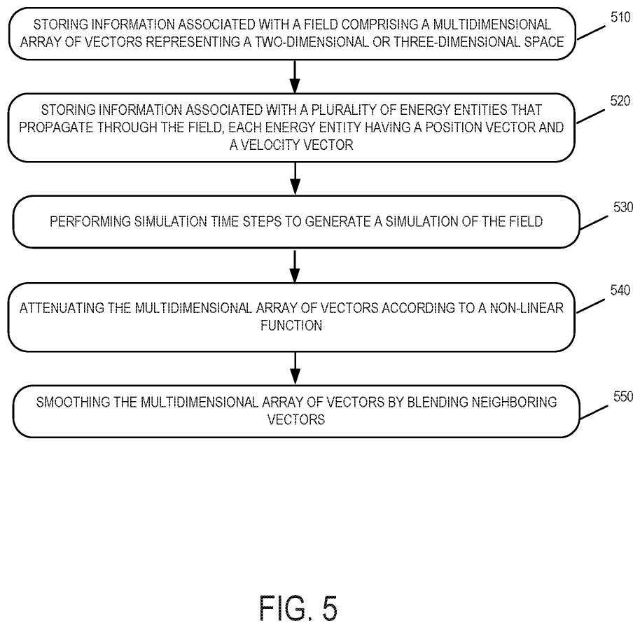

FIG. 5 shows a flowchart of a method 500 of executing a simulation by the computing device 102 according to an example of the instant disclosure. Although the example method 500 depicts a particular sequence of operations, the sequence may be altered without departing from the scope of the present disclosure. For example, some of the operations depicted may be performed in parallel or in a different sequence that does not materially affect the function of the method 500. In other examples, different components of an example device or system that implements the method 500 may perform functions at substantially the same time or in a specific sequence.

According to some examples, the method 500 may include storing 510 information associated with a field comprising a multidimensional array of vectors representing a two-dimensional space or a three-dimensional space. Next, the method 500 includes storing 520 information associated with a plurality of energy entities that propagate through the field, each energy entity having a position vector and a velocity vector. Then, the computing device 102 performs 530 simulation time steps to generate a simulation of the field. In one embodiment, each simulation time step includes, for each energy entity, calculating a velocity offset based on a weighted average of neighboring velocity vectors in the field, weighted by distance, adding a velocity offset to the velocity vector, and adding the velocity offset to the position vector. Then, for each field position in the field, the method 500 includes calculating a value offset based on neighboring energy entities and adding the value offset to the field position. Next, the computing device 102 attenuates 540 the multidimensional array of vectors according to a non-linear function that reduces each vector in the multidimensional array of vectors at a rate proportionate to a magnitude of each vector. Then, the method 500 includes smoothing 550 the multidimensional array of vectors by blending neighboring vectors.

According to some examples, the method 500 may include measuring a change in time between simulation time steps and scaling effects by the change in time.

In another example, the method 500 may include receiving input to at least one user interface element to modify a representation of the simulation, the at least one user interface element having tunable behaviors including at least one of: energy entity speed or initial speed, energy entity field sensitivity, energy displacement strength, energy displacement shape, field normalization rate, field blend rate, and field type.

In another example, the method 500 may include emulating steering each energy entity, wherein the velocity vector is altered by a difference in field displacement.

In another example, each energy entity includes an energy type having a number of tunable behaviors comprising at least one of a non-directional displacement, a competing field normalization effect around the energy entity, and steering based on how displacement and normalization differ from the energy entity in isolation.

In another example, each energy entity and the field operate on copies of each energy entity and/or vector data in a different order or simultaneously using a separate process.

In one example, the field is a director field and an energy speed is renormalized to an original speed after each adjustment.

In another example, the field is a vector field and energy interprets a field value as an acceleration up to a configured maximum speed, using a function that scales acceleration lower as the acceleration approaches the maximum speed.

In another example, the field is a pressure field and energy interprets a difference in field values between a prior position and a future position, as calculated by the associated velocity vector, as an acceleration.

In a further example, the field is a combined field based on a vector field and a pressure field, and energy accelerates using the vector field and decelerates using pressure logic associated with the pressure field.

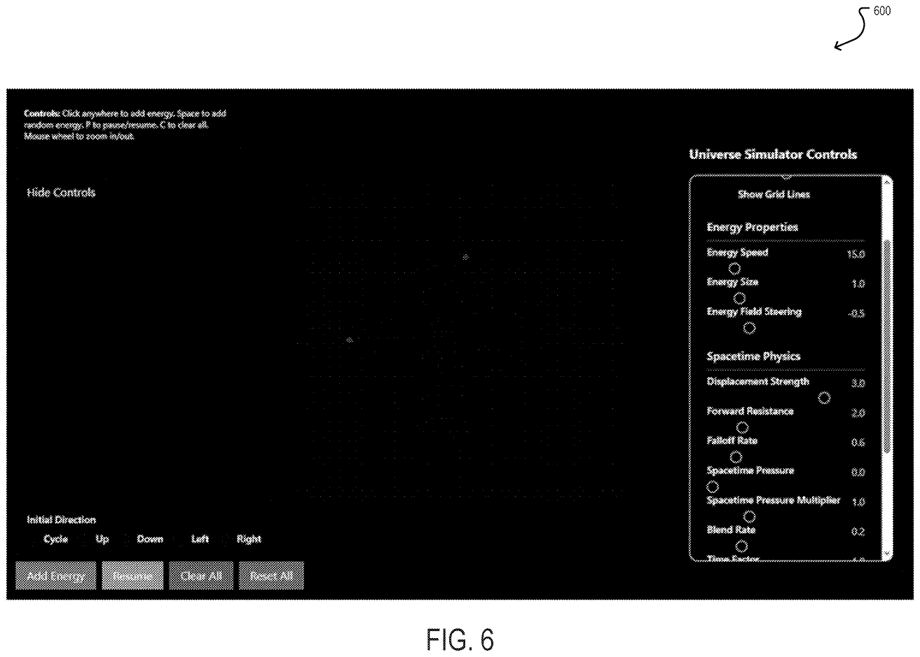

FIG. 6 is a screenshot 600 of a graphical user interface of the configurable field and energy emulation application 110 according to an example of the instant disclosure. As shown in FIG. 6, energy is displacing the field. The user may select a point in the graphical user interface to add energy, may add random energy, pause or resume the simulation, clear energy, and zoom in or out.

In one example, there may be user interface elements including buttons such as “Add Energy,” “Resume,” “Clear All,” and “Reset All.” The buttons are shown, for example, in a bottom left of the user interface. There also may be set of knobs or universe simulator controls that may be in a panel that may be located on a right side of the user interface. In one example, each of the knobs may be sliders that may be selected by a user and moved such as energy properties associated with energy speed, energy size, and energy field steering and field physics knobs associated with displacement strength, forward resistance, falloff rate, field normalization, field normalization multiplier, blend rate, time factor, linear time effects including show time effects, energy base shed rate, energy displacement shed rate, and energy shed factor, among others.

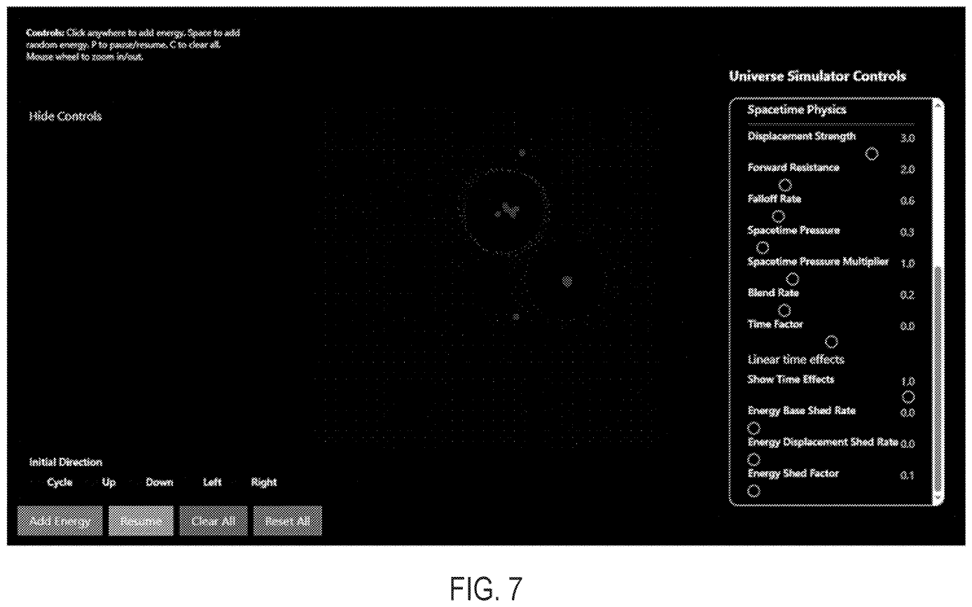

FIG. 7 is a screenshot 700 of the graphical user interface of the configurable field and energy emulation application 110 according to an example of the instant disclosure. In FIG. 7, there are a number of energy entities that have been added to the simulation.

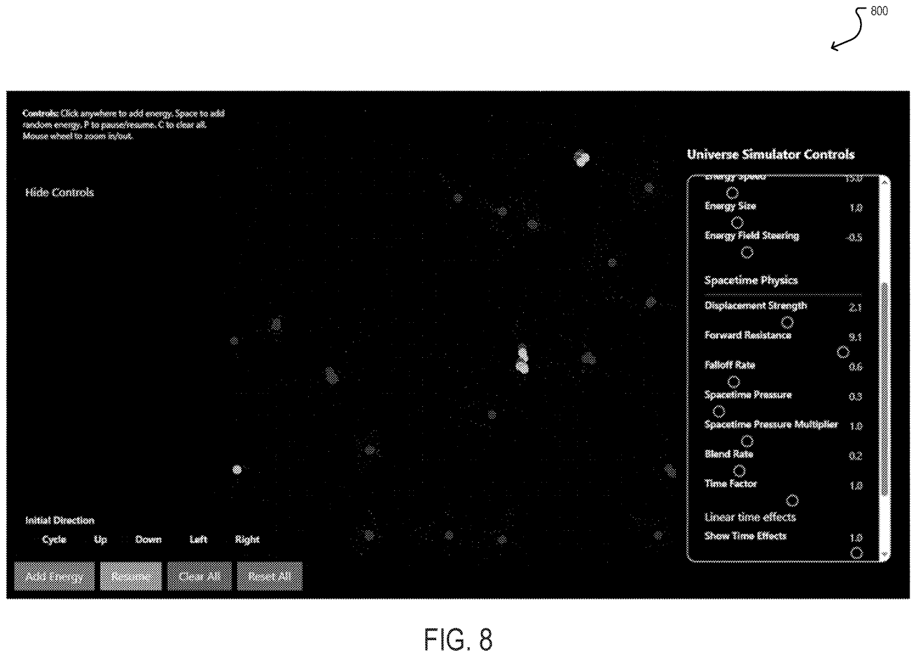

FIG. 8 is a screenshot 800 of the graphical user interface of the configurable field and energy emulation application 110 according to an example of the instant disclosure. In FIG. 8, there are more energy entities than in FIG. 7.

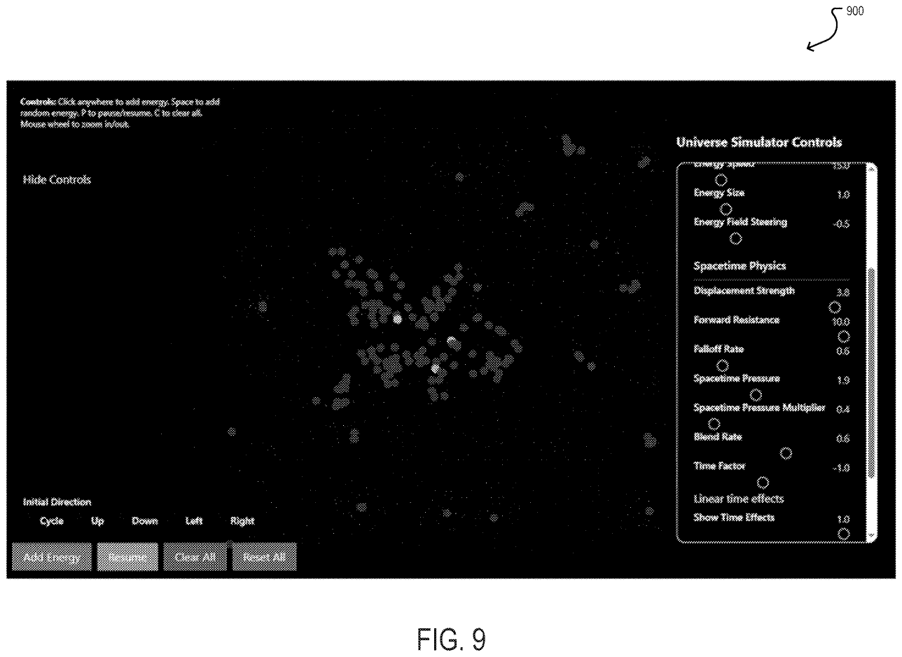

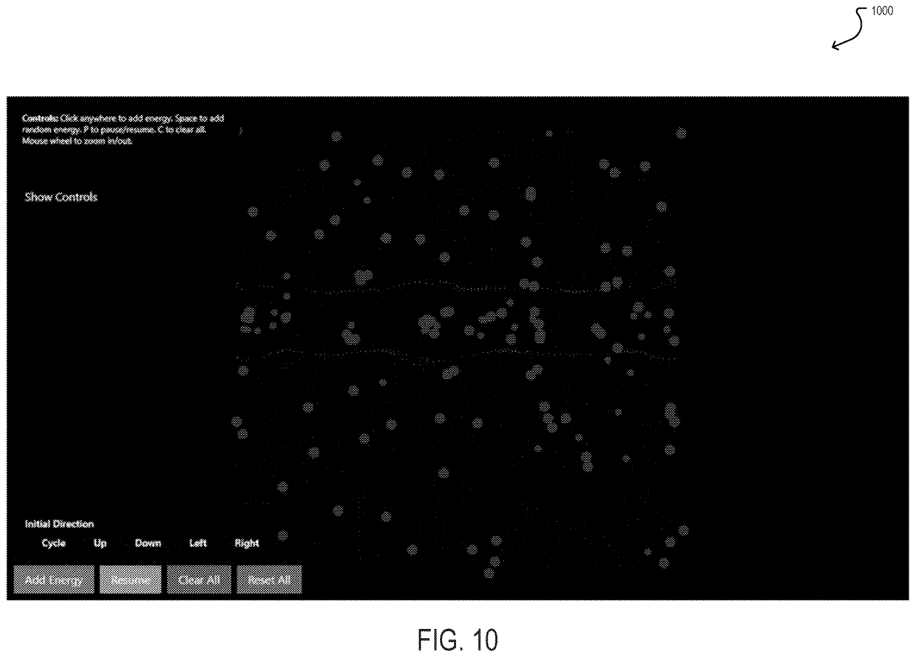

FIG. 9 is a screenshot 900 of the graphical user interface of the configurable field and energy emulation application 110 according to an example of the instant disclosure. Again, in FIG. 9, there are a number of energy entities added to the simulation.

FIG. 10 is a screenshot 1000 of the graphical user interface of the configurable field and energy emulation application 110 according to an example of the instant disclosure. FIG. 10 shows an example with different energy sizes.

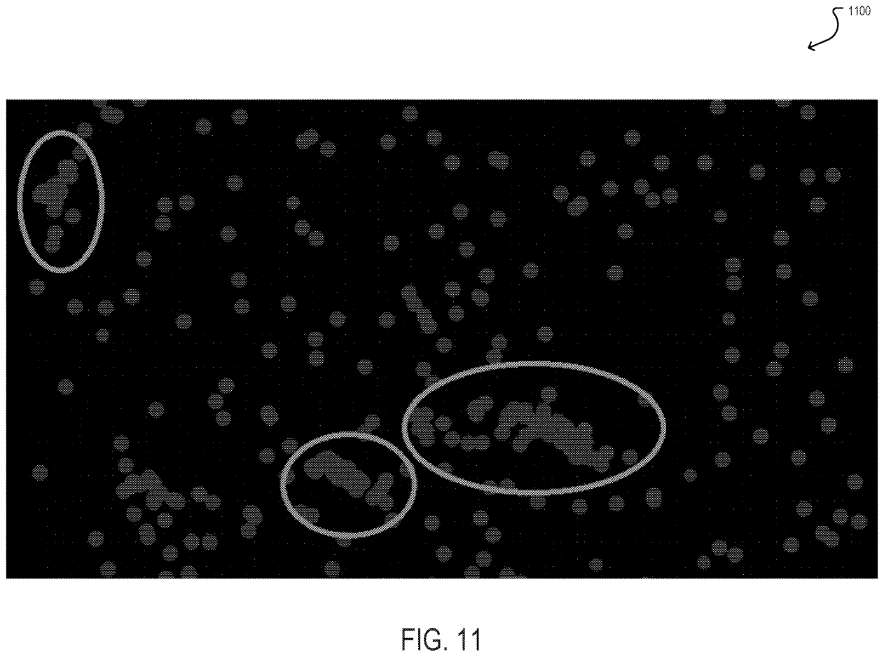

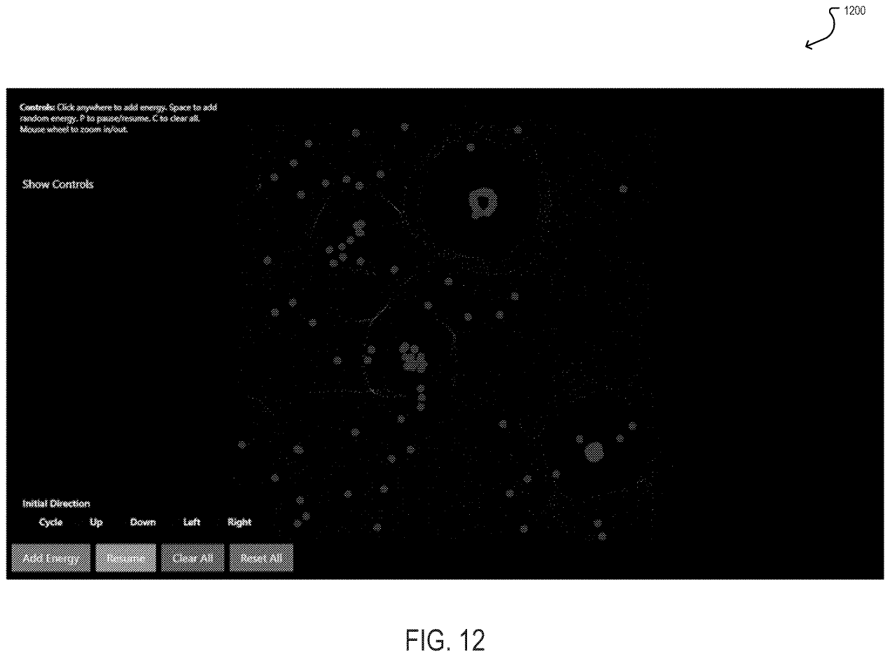

FIG. 11 is a screenshot 1100 of the graphical user interface of the configurable field and energy emulation application 110 according to an example of the instant disclosure. FIG. 11 shows an example of energy moving in a shape/form of a squid-like creature.

FIG. 12 is a screenshot 1200 of the graphical user interface of the configurable field and energy emulation application 110 according to an example of the instant disclosure. In FIG. 12, some of the energy entities are combining together into larger groupings of energy that together form shapes.

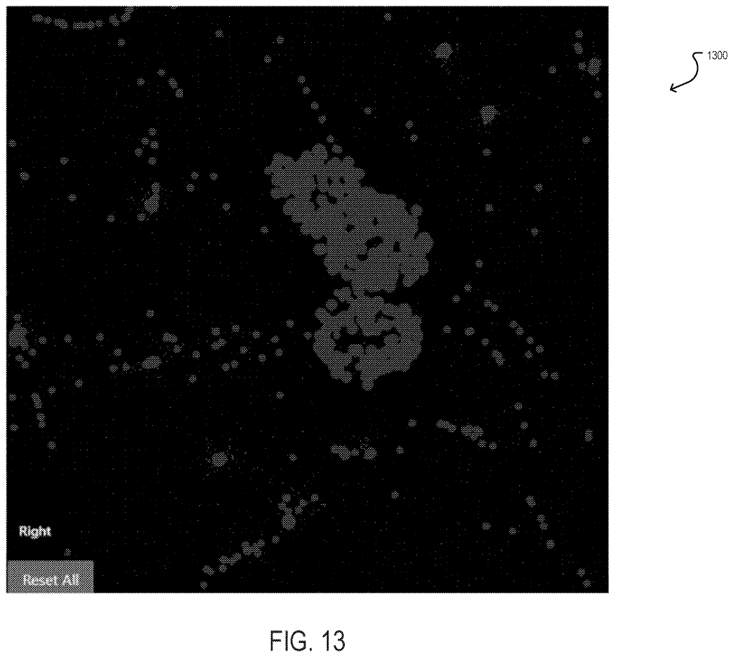

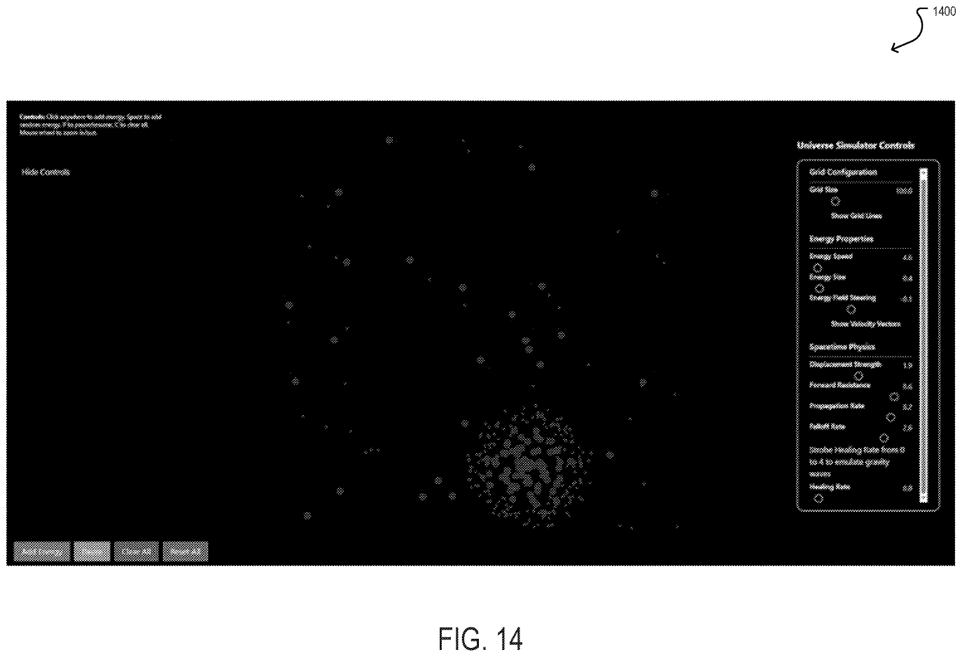

FIG. 13 is a screenshot 1300 of the graphical user interface of the configurable field and energy emulation application 110 according to an example of the instant disclosure. FIG. 13 shows an example of biological shapes emerging from the field.

FIG. 14 is a screenshot 1400 of the graphical user interface of the configurable field and energy emulation application 110 according to an example of the instant disclosure. FIG. 14 shows an example of self-assembling structures similar to molecules.

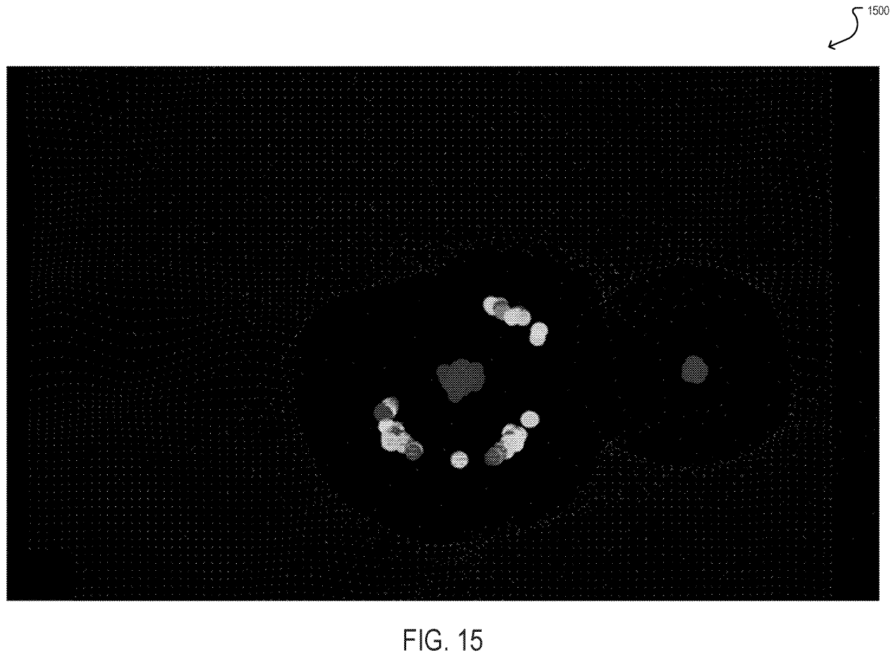

FIG. 15 is a screenshot 1500 of the graphical user interface of the configurable field and energy emulation application 110 according to an example of the instant disclosure. FIG. 15 shows an example of strong nuclear force and emulated relativity effects.

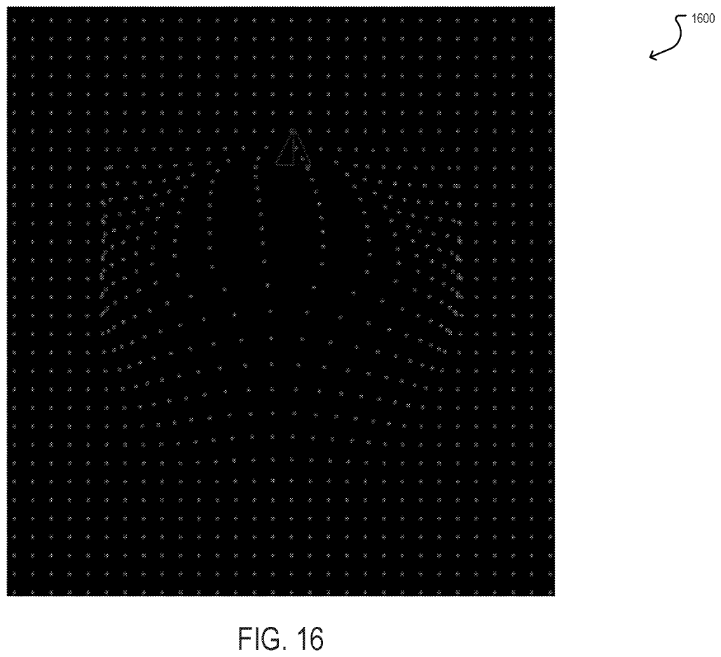

FIG. 16 is a screenshot 1600 of a dome displacement type according to an example of the instant disclosure. This is a default and acts more like a “snow plow.”

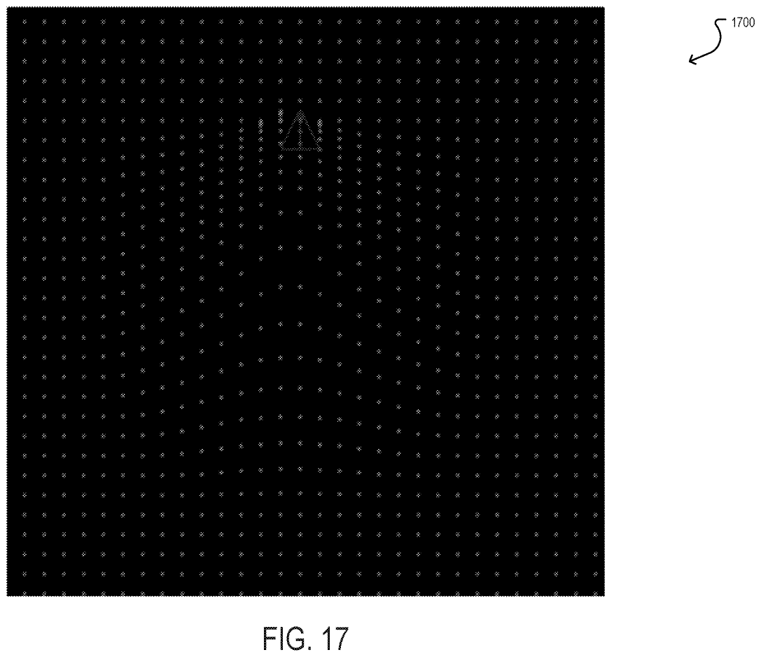

FIG. 17 is a screenshot 1700 of a wave displacement type according to an example of the instant disclosure. This is an alternative and acts more like a wave front.

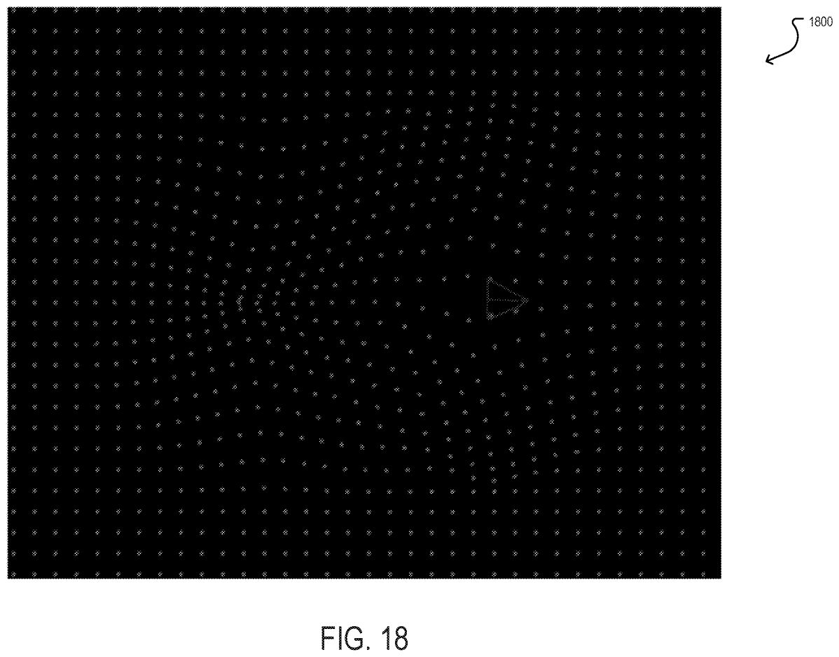

FIG. 18 is a screenshot 1800 of a wake vortex according to an example of the instant disclosure. Wake vortexes displace ahead of the energy entity as before, but invert the tail-side, pulling in rather pushing out. This creates a shape similar to a magnetotail.

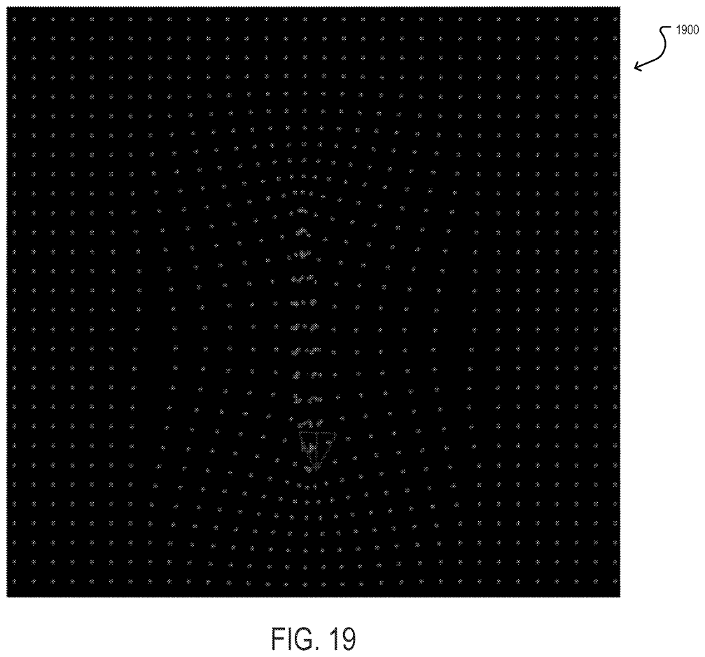

FIG. 19 is a screenshot 1900 of a vacuum according to an example of the instant disclosure. This displacement type “sucks in” toward the middle rather than displaces away.

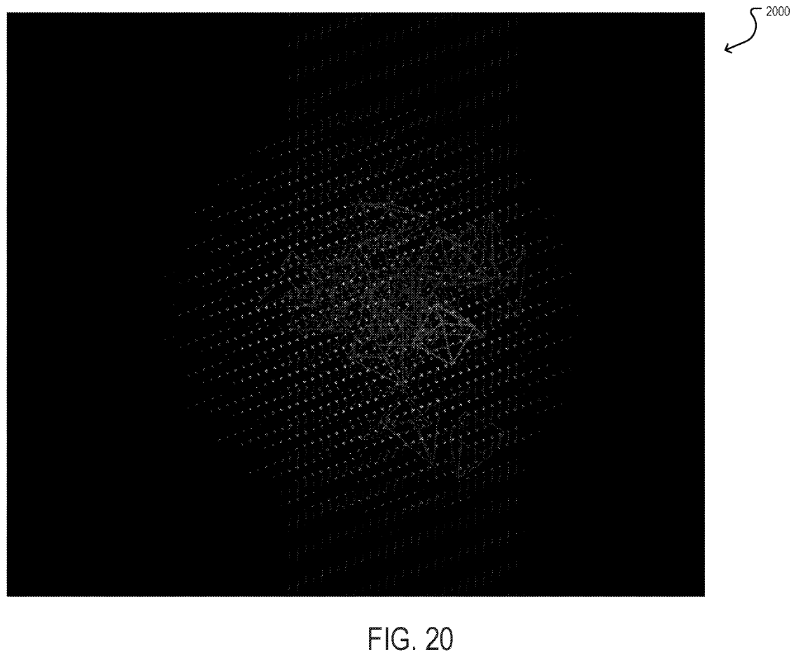

FIG. 20 is screenshot 2000 of a heat field according to an example of the instant disclosure.

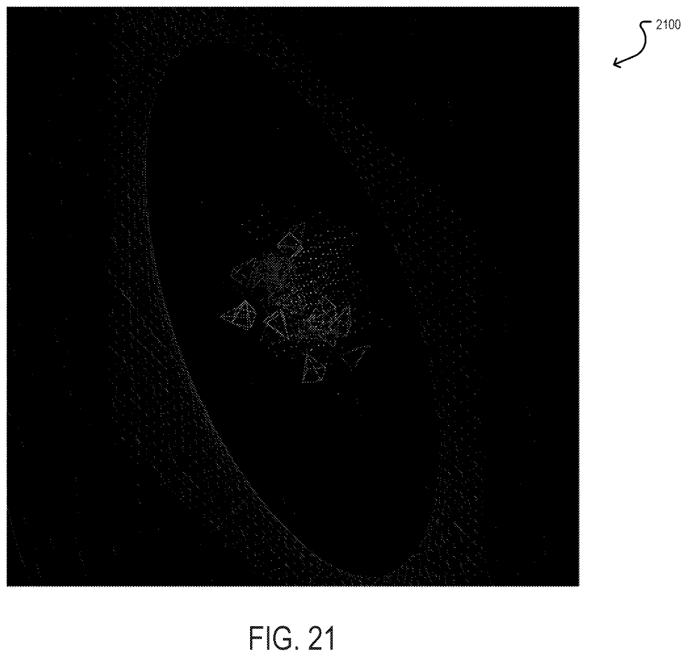

FIG. 21 is a screenshot 2100 of 3D field torque according to an example of the instant disclosure.

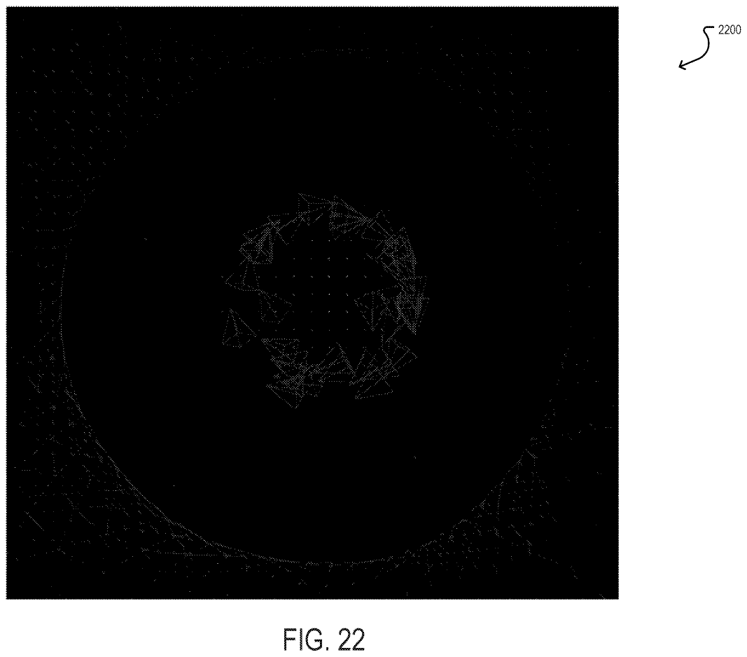

FIG. 22 is a screenshot 2200 of an overhead view of toroid/vortex formation according to an example of the instant disclosure.

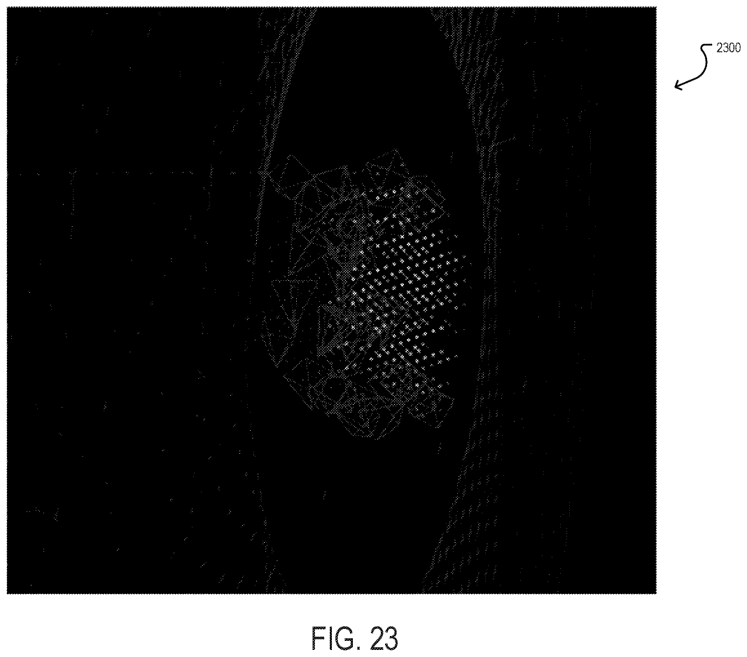

FIG. 23 is a screenshot 2300 of a side view of the toroid/vortex with field torque visible according to an example of the instant disclosure.

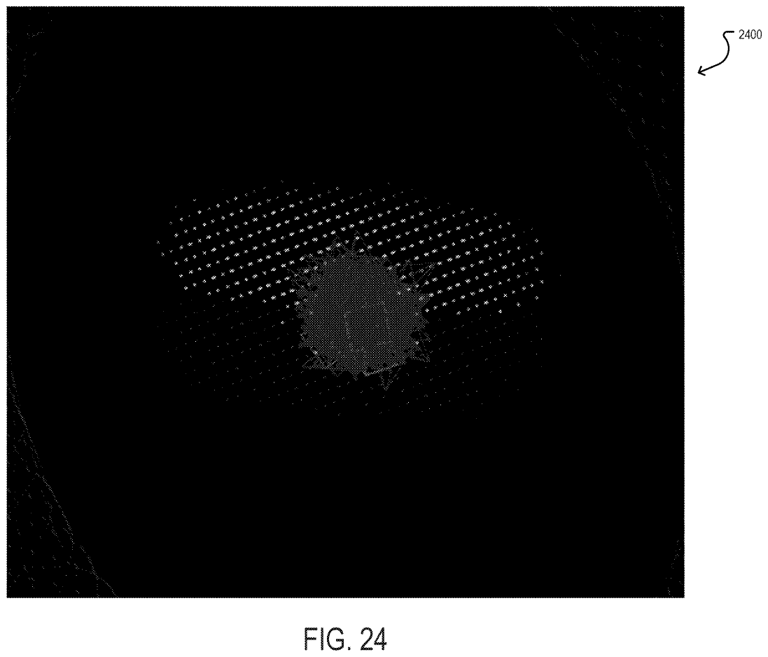

FIG. 24 is a screenshot 2400 of 3D remnant field torque after a torus turns star-like according to an example of the instant disclosure.

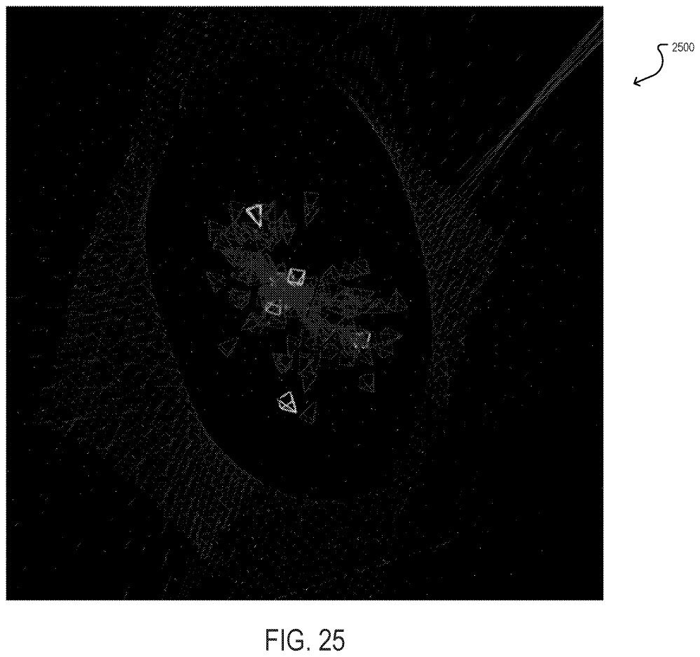

FIG. 25 is a screenshot 2500 of 3D dipole/jetting according to an example of the instant disclosure.

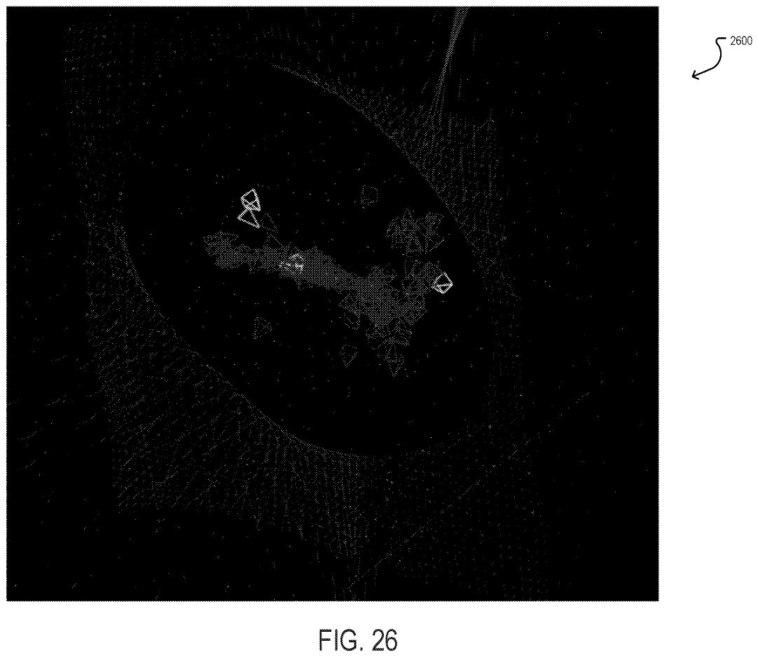

FIG. 26 is a screenshot 2600 of 3D bar formation according to an example of the instant disclosure.

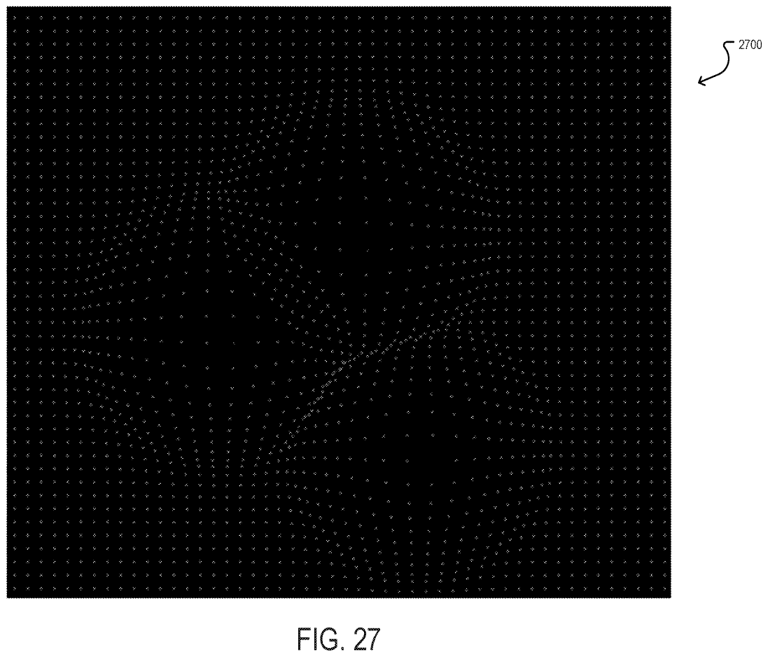

FIG. 27 is a screenshot 2700 of diffuser particles naturally spacing out according to an example of the instant disclosure.

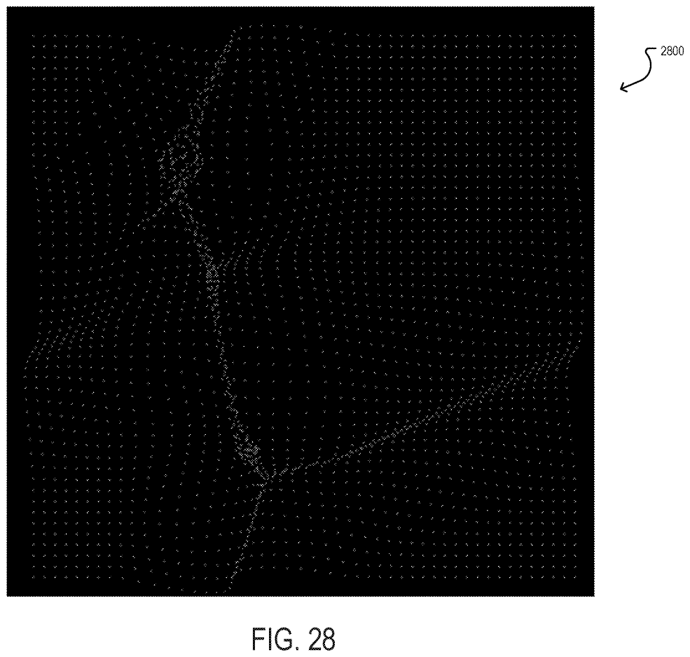

FIG. 28 is a screenshot 2800 of thread/filament wake from diffuser type (e.g., plausible entanglement mechanism) according to an example of the instant disclosure.

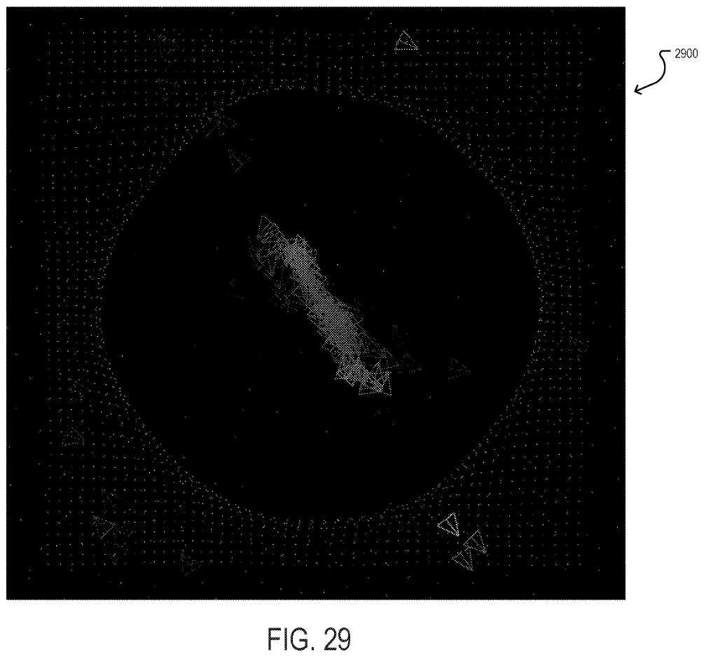

FIG. 29 is a screenshot 2900 of a bar with jetting according to an example of the instant disclosure.

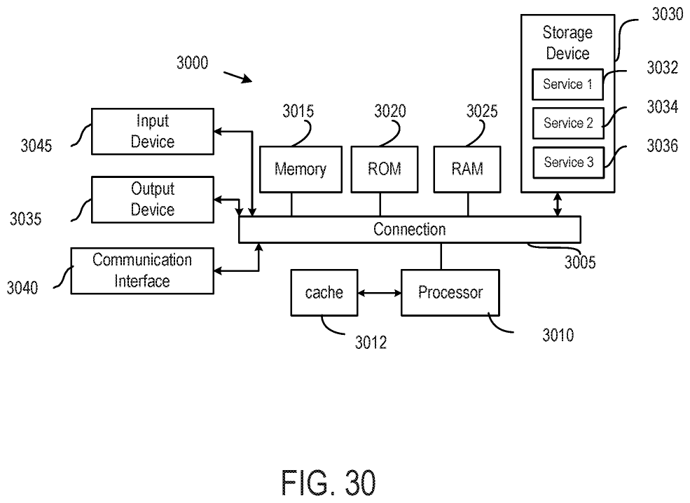

FIG. 30 shows an example of computing system 3000, which can be, for example, the computing device 102, or any component thereof in which the components of the system are in communication with each other using connection 3005. Connection 3005 can be a physical connection via a bus, or a direct connection into processor 3010, such as in a chipset architecture. Connection 3005 can also be a virtual connection, networked connection, or logical connection.

In some embodiments, computing system 3000 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 3000 includes at least one processing unit (CPU or processor) 3010 and connection 3005 that couples various system components including system memory 3015, such as read-only memory (ROM) 3020 and random access memory (RAM) 3025 to processor 3010. Computing system 3000 can include a cache of high-speed memory 3012 connected directly with, in close proximity to, or integrated as part of processor 3010.

Processor 3010 can include any general purpose processor and a hardware service or software service, such as services 3032, 3034, and 3036 stored in storage device 3030, configured to control processor 3010 as well as a special-purpose processor where software instructions are incorporated into the actual processor design. Processor 3010 may essentially be a completely self-contained computing system, containing multiple cores or processors, a bus, memory controller, cache, etc. A multi-core processor may be symmetric or asymmetric.

To enable user interaction, computing system 3000 includes an input device 3045, which can represent any number of input mechanisms, such as a microphone for speech, a touch-sensitive screen for gesture or graphical input, keyboard, mouse, motion input, speech, etc. Computing system 3000 can also include output device 3035, which can be one or more of a number of output mechanisms known to those of skill in the art. In some instances, multimodal systems can enable a user to provide multiple types of input/output to communicate with computing system 3000. Computing system 3000 can include communications interface 3040, which can generally govern and manage the user input and system output. There is no restriction on operating on any particular hardware arrangement, and therefore the basic features here may easily be substituted for improved hardware or firmware arrangements as they are developed.

Storage device 3030 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 3030 can include software services, servers, services, etc., that when the code that defines such software is executed by the processor 3010, it causes the system to perform a function. In some embodiments, a hardware service that performs a particular function can include the software component stored in a computer-readable medium in connection with the necessary hardware components, such as processor 3010, connection 3005, output device 3035, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method comprising:
storing, by at least one processor, information associated with a field comprising a multidimensional array of vectors representing a two-dimensional space or a three-dimensional space;
storing, by the at least one processor, information associated with a plurality of energy entities that propagate through the field, each energy entity having a position vector and a velocity vector;
performing, by the at least one processor, simulation time steps to generate a simulation of the field, each simulation time step comprising:
for each energy entity:
calculating a velocity offset based on a weighted average of neighboring velocity vectors in the field, weighted by distance;
adding a velocity offset to the velocity vector; and
adding the velocity offset to the position vector;
for each field position in the field:
calculating a value offset based on neighboring energy entities; and
adding the value offset to the field position;
attenuating, by the at least one processor, the multidimensional array of vectors according to a non-linear function that reduces each vector in the multidimensional array of vectors at a rate proportionate to a magnitude of each vector; and
smoothing, by the at least one processor, the multidimensional array of vectors by blending neighboring vectors.

2. The method of claim 1, further comprising measuring a change in time between simulation time steps and scaling effects by the change in time.

3. The method of claim 1, further comprising:
receiving input to at least one user interface element to modify a representation of the simulation, the at least one user interface element having tunable behaviors comprising at least one of: energy entity speed or initial speed, energy entity field sensitivity, energy displacement strength, energy displacement shape, field normalization rate, field blend rate, and field type.

4. The method of claim 1, further comprising:
emulating steering each energy entity, wherein the velocity vector is altered by a difference in field displacement.

5. The method of claim 1, wherein each energy entity comprises an energy type having a number of tunable behaviors comprising at least one of a non-directional displacement, a competing field normalization effect around the energy entity, and steering based on how displacement and normalization differ from the energy entity in isolation.

6. The method of claim 1, wherein each energy entity and the field operate on copies of each energy entity and/or vector data in a different order or simultaneously using a separate process.

7. The method of claim 1, wherein the field is a director field and an energy speed is renormalized to an original speed after each adjustment.

8. The method of claim 1, wherein the field is a vector field and energy interprets a field value as an acceleration up to a configured maximum speed, using a function that scales acceleration lower as the acceleration approaches the maximum speed.

9. The method of claim 1, wherein the field is a pressure field and energy interprets a difference in field values between a prior position and a future position, as calculated by the associated velocity vector, as an acceleration.

10. The method of claim 1, wherein the field is a combined field based on a vector field and a pressure field, and energy accelerates using the vector field and decelerates using pressure logic associated with the pressure field.

11. A system comprising:
a computing device comprising a memory storing computer-readable instructions; and
at least one processor to execute the instructions to:
store information associated with a field comprising a multidimensional array of vectors representing a two-dimensional space or a three-dimensional space;
store information associated with a plurality of energy entities that propagate through the field, each energy entity having a position vector and a velocity vector;
perform simulation time steps to generate a simulation of the field, each simulation time step comprising:
for each energy entity:
calculating a velocity offset based on a weighted average of neighboring velocity vectors in the field, weighted by distance;
adding a velocity offset to the velocity vector; and
adding the velocity offset to the position vector;
for each field position in the field:
calculating a value offset based on neighboring energy entities; and
adding the value offset to the field position;
attenuate the multidimensional array of vectors according to a non-linear function that reduces each vector in the multidimensional array of vectors at a rate proportionate to a magnitude of each vector; and
smooth the multidimensional array of vectors by blending neighboring vectors.

12. The system of claim 11, the at least one processor further to execute the instructions to:
measure a change in time between simulation time steps and scaling effects by the change in time.

13. The system of claim 11, the at least one processor further to execute the instructions to:
receive input to at least one user interface element to modify a representation of the simulation, the at least one user interface element having tunable behaviors comprising at least one of: energy entity speed or initial speed, energy entity field sensitivity, energy displacement strength, energy displacement shape, field normalization rate, field blend rate, and field type.

14. The system of claim 11, the at least one processor further to execute the instructions to:
emulate steering each energy entity, wherein the velocity vector is altered by a difference in field displacement.

15. The system of claim 11, wherein each energy entity comprises an energy type having a number of tunable behaviors comprising at least one of a non-directional displacement, a competing field normalization effect around the energy entity, and steering based on how displacement and normalization differ from the energy entity in isolation.

16. The system of claim 11, wherein each energy entity and the field operate on copies of each energy entity and/or vector data in a different order or simultaneously using a separate process.

17. The system of claim 11, wherein the field is a director field and an energy speed is renormalized to an original speed after each adjustment.

18. The system of claim 11, wherein the field is a vector field and energy interprets a field value as an acceleration up to a configured maximum speed, using a function that scales acceleration lower as the acceleration approaches the maximum speed.

19. The system of claim 11, wherein the field is a pressure field and energy interprets a difference in field values between a prior position and a future position, as calculated by the associated velocity vector, as an acceleration.

20. The system of claim 11, wherein the field is a combined field based on a vector field and a pressure field, and energy accelerates using the vector field and decelerates using pressure logic associated with the pressure field.
